(19) United States
(12) Patent Application Publication
(10) Pub. No.: US 2025/0182754 A1
(43) Pub. Date: Jun. 5, 2025

(54) Program Enablement with Speech-Enabled Conversational Interactions

(71) Applicant: Antoine Saad, MAHOPAC, NY (US)

(72) Inventor: Antoine Saad, MAHOPAC, NY (US)

(21) Appl. No.: 18/526,118

(22) Filed: Dec. 1, 2023

(51) Int. Cl. G10L 15/22; G10L 13/02; G10L 21/0208; G10L 25/78

(52) U.S. Cl. CPC G10L 15/22; G10L 13/02; G10L 21/0208; G10L 25/78; G10L 2021/02082

(57) ABSTRACT

Frameworks, interfaces and configurable data structures are disclosed that enable programs to execute speech-enabled conversational interactions and processes with their users. In accordance with one or more examples, a method includes, at an electronic device with one or more processors and memory: providing a program the capability to conduct speech-enabled conversational interactions with a user; loading, interpreting and processing configurable structured data which drive the execution of speech-enabled interactions between a program and a user; listening to and processing real time events and requests from a program, electronic device or other programs executing on the device; and, making real-time adaptations to conversational interactions. A program executing on an electronic device and using the invention frameworks and interfaces, specifies, and without limitation: the configured data structures for the frameworks in the invention to process; and a plurality of conversational speech capabilities to request from the frameworks of the invention.

### FIELD OF THE INVENTION

This relates generally to software frameworks interpreting and processing configurable data structures provided by a program running on an electronic device in order to generate and execute speech-enabled conversational interactions and processes between the program and users of the program.

### Terminology

“Device” is defined as an electronic device with one or more processors, with memory, with one or more audio input devices such as microphones and with one or more audio output devices such as speakers.

“Program” is defined as a single complete program installed and can run on Device. Program is comprised of one or a plurality of Program modules. The singular form “Program” is intended to include the plural forms as well, unless the context clearly indicates otherwise. “Program” also references and intends to represent its Program modules.

“Program Module” is defined as one or a plurality of Program modules that Program comprises. The singular form “Program Module” is intended to include the plural forms as well, unless the context clearly indicates otherwise.

“User” is defined as Program user.

“VFF” is defined as the Voice Flow Framework and its interfaces in accordance with the embodiment of the present invention.

“MF” is defined as the Media Framework and its interfaces in accordance with the embodiment of the present invention.

“CVFS” is defined as the Conversational Voice Flow system which comprises VFF and MF.

“VFC”, or “Voice Flow Client”, is defined as a client-side software module, application or program component that Program implements to integrate and interface with VFF and MF, according to various examples and embodiments.

“VoiceFlow” is defined as a designable and configurable data structure or a plurality of data structures that define and specify the speech-enabled conversational interaction, between Program and User, when interpreted and processed by VFF, in accordance with the embodiment of the present invention. The singular form “VoiceFlow” is intended to include the plural forms as well, unless the context clearly indicates otherwise.

“VFM”, or “VF Module”, or “Voice Flow Module” is a fundamental component of VoiceFlow and is defined as a designable and configurable data structure in a VoiceFlow. VoiceFlow is comprised of a plurality of VFMs of different types. The singular form “VFM”, or “VF Module” is intended to include the plural forms as well, unless the context clearly indicates otherwise.

“Format” is defined as a data structure format used to configure a VoiceFlow, for example, but not limited to, JSON and XML.

“Callback” is defined as one or a plurality of event notification functions and object callbacks conducted by VFF and MF to Program through Program's implementation of VFC, according to various examples and embodiments. The singular form “Callback” is intended to include the plural forms as well, unless the context clearly indicates otherwise.

“Audio Segment” is defined as a single segment of raw audio data for audio playback in Program on Device to User or to other destinations, either recorded and located at a URL or streamed from an audio source such as, but not limited to, a Device file or a speech synthesizer. The singular form “Audio Segment” is intended to include the plural forms as well, unless the context clearly indicates otherwise.

“APM”, or “Audio Prompt Module” is defined as a designable and configurable data structure that either defines and specifies a single Audio Segment with its audio playback parameters and specifications, or defines and specifies references to a set of other Audio Prompt Modules, along with their audio playback parameters and specifications, which, when referenced in VFMs and interpreted and processed by VFF and MF, result in single or multiple audio playbacks by Program on Device to User or to other destinations, in accordance with the embodiment of the present invention. The singular form “APM”, or “Audio Prompt Module”, is intended to include the plural forms as well, unless the context clearly indicates otherwise.

“SR Engine” is defined as a speech recognizer engine.

“SS Engine” is defined as a speech synthesizer engine.

“VAD” is defined as Voice Activity Detector or Voice Activity Detection.

“AEC” is defined as Acoustic Echo Canceler or Acoustic Echo Canceling.

“Process VFM” is defined as a VFM of type “process”.

“PauseResume VFM” is defined as a VFM of type “pauseResume”.

“PlayAudio VFM” is defined as a VFM of type “playAudio”.

“RecordAudio VFM” is defined as a VFM of type “recordAudio”.

“AudioDialog VFM” is defined as a VFM of type “audioDialog”.

“AudioListener VFM” is defined as a VFM of type “audioListener”.

### BACKGROUND OF THE INVENTION

As aforementioned in the “TERMINOLOGY” section, VoiceFlow refers to a set of designable and configurable data structured lists representing speech-enabled interactions and processing modules, and the interactive sequence of spoken dialog and processes between Program and User. At Program running on Device, interpreting and processing VoiceFlow encompasses a User's back-and-forth conversational dialog with Program through the exchange of spoken words and phrases coupled with other input modalities such as, but not limited to, mouse, Device touch pad, keyboard, virtual keyboard, Device touch screen, eye tracking and finger tap inputs, where, according to various examples, User provides voice input and requests to Program, and Program responds with appropriate voice output accompanied by Program automatically and visibly rendering the user's input into visible actions and updates on Device screen. Processing VoiceFlows not only aims to emulate natural human conversation allowing Users to interact with Program using their voice, just as they would in a conversation with another person, but also provides a speech interaction modality that complements or replaces other interaction modalities for Program.

Processing VoiceFlows for Program involves execution of various functionalities comprising speech-enabled conversational dialogs, speech recognition, natural language processing, context management, dialog management, Artificial Intelligence (AI), Device event detection and handling, Program views rendering, integration with Programs and their visible User interfaces, and bidirectional real-time communication between speech input and other input modalities to Program, to understand and interpret User intents, to provide relevant responses, to execute visible or audible actions on the visible or audible Program User Interface and to maintain coherent and dynamic conversations while balancing between User's speech input and inputs from other sources to Program. This is coupled with the real-time intelligent handling of Device events while Program is processing VoiceFlows. VoiceFlows enable intuitive hands-free or hands-voice partnered interactions, enhancing User convenience and providing more engaging, natural and personalized experiences.

Programs generally do not include speech as an alternate input modality due to complexities of such implementations which comprise: Adding speech input functionality to a Program and integrating with other input modalities, such as hand touch, requires significant effort and expertise in areas such as voice recognition, natural language processing, text-to-speech conversion, context extraction, automatic Program views rendering, multiple input modalities, event signaling with real-time rendering and real-time Device and Program event handling.

### SUMMARY OF THE INVENTION

Frameworks, interfaces and configurable data structures for enabling, interpreting and executing speech-enabled conversational interactions and processes in Programs are provided.

In accordance with one or more examples, a function includes, at Program running on Device: frameworks embodied in the present invention receiving requests from Program to select and load specific media modules that are either available on Device, or available from external sources, to allocate to Program. In accordance with the determination that the media modules requested are valid and available for allocation to Program, the function includes loading and starting the media modules requested. The function also includes the transition of the frameworks to a ready state to accept requests from Program to load and execute speech-enabled conversational interactions with User.

In accordance with one or more examples, a function includes, at Program running on Device: frameworks embodied in the present invention receiving a request from Program to define a category of the audio session to execute for Program. In accordance with the determination that the audio session category selected is valid, the function includes configuring the category for the audio session, and allocating and assigning the audio session to Program. Examples of audio session categories comprise defaulting to a specific output audio device for Program on Device, mixing Program audio playback with audio playback from other programs, or duck audio of other programs.

In accordance with one or more examples, a function includes, at Program running on Device: frameworks embodied in the present invention receiving a request from Program to load and process a VoiceFlow. In accordance with the determination that the VoiceFlow is accessible to load and is validated to be free of configuration errors, the function includes processing the entry VFM in the VoiceFlow and the transition to process other configured VFMs in the VoiceFlow based on sequences and decisions depicted by the VoiceFlow configuration. The function includes processing configured VFMs with a plurality of VFM types. For example, in accordance with determination that a VFM is Process VFM, the function includes executing relevant processes and managing data assignments associated with the parameters of the VFM, then the act of transitioning to the next VFM depicted by the configured logic interpreted in the current VFM. Another example, in accordance with determination that a VFM is PlayAudio VFM, the function includes loading and processing audio playback functionality as configured in APMs referenced in the VFM configuration. The APM configurations may contain a reference to a single audio segment or may contain references to other configured APMs, to be rendered according to the parameters specified in the VFM and the APMs. Another example, in accordance with determination that a module is AudioDialog VFM, the function includes loading and processing a complete speech-enabled conversational dialog interaction between Program and User comprised of processing “initial” type APMs, “retry” type APMs, “error” type APMs, error handling, configuration of audio timeouts, User interruption of audio playback (hereafter “Barge-In”), VAD, executing speech recognition and speech synthesis functionalities, real-time evaluation of user speech input, and handling other programs and Device event notifications that may impact the execution of Program. The function also includes the transition to the next VFM depicted by the configured logic interpreted in the current VFM.

In accordance with one or more examples, a function includes, at Program running on Device: frameworks embodied in the present invention receiving requests from Program, directly through an interface or through a configured VFM, to execute processes of plurality of types. In accordance with the determination that a process type is valid and available for Program, the function includes executing the process following the parameters configured in VFM for the process. Process types comprise: recording audio from an audio source such as an audio device, a source URL or a speech synthesizer; streaming or playing audio to an audio destination such as an audio device, a destination URL or a speech recognizer; performing VAD and VAD parameter adaptation and signaling; and switching among different input audio devices and among different output audio devices for Program on Device.

### BRIEF DESCRIPTION OF DRAWINGS

FIG. 1 illustrates a portable multifunction Device 10 and a Program 12, installed on Device 10, that implements VFC 16 for Program 12 to integrate with the current invention CVFS 100, according to various examples and in accordance with a preferred embodiment of the present invention.

FIG. 2 is a component diagram illustrating frameworks and modules in system and environment, which CVFS 100 comprises according to various examples and in accordance with a preferred embodiment of the present invention.

FIG. 3 is a simplified block diagram illustrating the fundamental architecture, structure and operation of the present invention as a component of a Device Program, according to various examples and in accordance with a preferred embodiment of the present invention.

FIG. 4 is a block diagram illustrating a system and environment for constructing a real-time Voice Flow Framework (hereafter “VFF 110”), as a component of the present invention, according to various examples and in accordance with a preferred embodiment of the present invention.

FIG. 5A is a block diagram illustrating a system and environment for constructing a real-time Media framework (hereafter “MF 210”), as a component of the present invention, according to various examples and in accordance with a preferred embodiment of the present invention.

FIG. 5B is a block diagram illustrating a system and environment for Speech Recognition and Speech Synthesis frameworks and interfaces embedded in or accessible by MF 210 illustrated in FIG. 5A, according to various examples and in accordance with a preferred embodiment of the present invention.

FIG. 6 is a simplified flow chart, illustrating operation of Program 12 while executing and interfacing with VFF 110 component from FIG. 4, as part of the present invention, according to various examples and in accordance with a preferred embodiment of the present invention.

FIG. 7 is a block diagram illustrating exemplary components for event handling in the present invention and for real-time Callbacks to Program 12, according to various examples and in accordance with a preferred embodiment of the present invention.

FIG. 8 is a simplified block diagram illustrating the fundamental architecture and methodology for creating, retrieving, updating and deleting dynamic run-time data in the present invention, according to various examples and in accordance with a preferred embodiment of the present invention.

FIG. 9 is a simplified flow chart, illustrating the operation of VFF 110 illustrated in FIG. 4, as part of the present invention, while VFF 110 processes a VoiceFlow 20, according to various examples and in accordance with a preferred embodiment of the present invention.

FIG. 10 is a simplified flow chart, illustrating the operation of VFF 110 illustrated in FIG. 4, as part of the present invention, while VFF 110 processes an interruption received from VFC 16, according to various examples and in accordance with a preferred embodiment of the present invention.

FIG. 11 is a simplified flow chart, illustrating the operation of VFF 110 illustrated in FIG. 4, as part of the present invention, while VFF 110 processes an interruption received from and external audio session, according to various examples and in accordance with a preferred embodiment of the present invention.

FIG. 12 is a simplified flow chart, illustrating the operation of VFF 110 illustrated in FIG. 4, as part of the present invention, while VFF 110 processes PauseResume VFM according to various examples and in accordance with a preferred embodiment of the present invention.

FIG. 13 is a simplified flow chart, illustrating the operation of VFF 110 illustrated in FIG. 4, as part of the present invention, while VFF 110 processes a Process VFM according to various examples and in accordance with a preferred embodiment of the present invention.

FIG. 14A is a simplified flow chart, illustrating the operation VFF 110 illustrated in FIG. 4, as part of the present invention, while VFF 110 processes PlayAudio VFM, according to various examples and in accordance with a preferred embodiment of the present invention.

FIG. 14B is a simplified flow chart, illustrating the operation of VFF 110 illustrated in FIG. 4, as part of the present invention, while VFF 110 loads and processes an Audio Segment for audio playback, during PlayAudio VFM processing as illustrated in FIG. 14A, according to various examples and in accordance with a preferred embodiment of the present invention.

FIG. 15A is a simplified flow chart, illustrating the operation of VFF 110 illustrated in FIG. 4, as part of the present invention, while VFF 110 processes RecordAudio VFM, according to various examples and in accordance with a preferred embodiment of the present invention.

FIG. 15B is a simplified flow chart, illustrating the operation of VFF 110 illustrated in FIG. 4, as part of the present invention, while VFF 110 loads “Record Audio” media parameters, for processing RecordAudio VFM as illustrated in FIG. 15A, according to various examples and in accordance with a preferred embodiment of the present invention.

FIG. 16 is a simplified flow chart, illustrating the operation of VFF 110 illustrated in FIG. 4, as part of the present invention, while VFF 110 processes AudioDialog VFM, according to various examples and in accordance with a preferred embodiment of the present invention.

FIG. 17 is a simplified flow chart, illustrating the operation of VFF 110 illustrated in FIG. 4, as part of the present invention, while VFF 110 processes AudioListener VFM, according to various examples and in accordance with a preferred embodiment of the present invention.

FIG. 18 is a simplified flow chart, illustrating the operation of VFF 110 illustrated in FIG. 4, as part of the present invention, while processing Speech Recognition Hypothesis (hereafter “SR Hypothesis”) events, during VFF 110 processing AudioDialog VFM as illustrated in FIG. 16 and processing AudioListener VFM as illustrated in FIG. 17, according to various examples and in accordance with a preferred embodiment of the present invention.

FIG. 19 illustrates sample configuration parameters for processing PlayAudio VFM as illustrated in FIG. 14A, and sample configuration for loading and processing an “Audio Segment” as illustrated in FIG. 14B, according to various examples and in accordance with a preferred embodiment of the present invention.

FIG. 20 illustrates sample configuration parameters for processing RecordAudio VFM as illustrated in FIG. 15A, and for loading “Record Audio” media parameters as illustrated in FIG. 15B, according to various examples and in accordance with a preferred embodiment of the present invention.

FIG. 21 illustrates sample configuration parameters for processing AudioDialog VFMs as illustrated in FIG. 16, sample configuration parameters for processing “AudioListener” VFMs as illustrated in FIG. 17 and sample configuration parameters for “Recognize Audio” used in processing AudioDialog and AudioListener VFMs, according to various examples and in accordance with a preferred embodiment of the present invention.

### DETAILED DESCRIPTION OF THE INVENTION

In the following description of embodiments, reference is made to the accompanying drawings in which are shown by way of illustration the architecture, functionality and execution process of the present invention. Reference is also made to some of the accompanying drawings in which are shown by way of illustration specific examples that can be practiced. It is to be understood that other examples can be used and structural changes can be made without departing from the scope of the various examples.

VFF 110, MF 210 and VoiceFlows, which enable a Program on Device to execute speech-enabled conversational interactions and processes with User, are described. Program defines the speech-enabled conversational interaction with User by designing and configuring VoiceFlows, by interfacing with VFF 110 and MF 210 and by passing VoiceFlows to VFF 110 for interpretation and processing through Program implementation of VFC 16 in accordance with various examples. VoiceFlows are comprised of a plurality of VFMs with different types, which, upon interpretation and processing by VFF 110 and with support of MF 210, result in speech-enabled conversational interactions between Program and User. During live processing of VoiceFlows, Callbacks enable Program to customize, interrupt and intercept VoiceFlow processing. This allows for dynamic adaptability to Program execution for best User experience to User and User's utilization of multiple input modalities to Program.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### 1. System and Environment

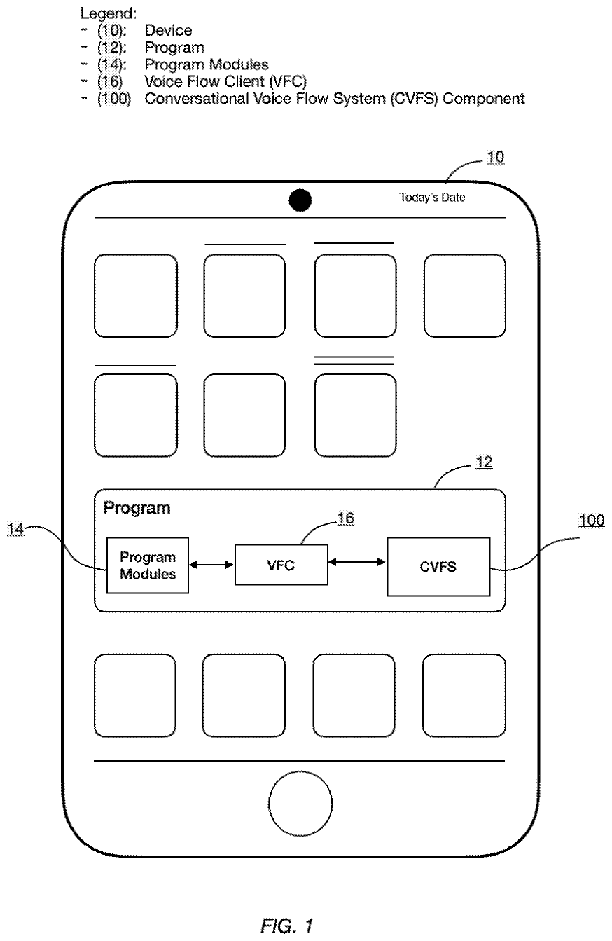

FIG. 1 illustrates an exemplary Device 10 and a Program 12 installed and can execute on Device 10, according to various examples and embodiments. In accordance with various examples, Program 12, or Program Modules 14 which Program 12 comprises, implement VFC 16 to support the execution of speech-enabled conversational interactions and processes. VFC 16 interfaces with CVFS 100 and requests CVFS 100 to process Program 12 provided VoiceFlows. According to various examples, VFC 16 implements Callback for CVFS 100 to Callback Program 12 and to pass VoiceFlow processing data and events through the Callback in order for Program 12 to process, to execute related and appropriate tasks and to adapt its User facing experience. Also, VFC 16 interfaces back with CVFS 100 during Callbacks to request changes, updates or interruptions to VoiceFlow processing.

In addition to the definition of Device under “Terminology” headline, Device 10 can be any suitable electronic device according to various examples. In some examples, Device is a portable multifunctional device or a personal electronic device. A portable multifunctional device is, for example, a mobile telephone that also contains other functions, such as PDA and/or music player functions. Specific examples of portable multifunction devices comprise the iPhone®, iPod Touch®, and iPad® devices from Apple Inc. of Cupertino, Calif. Other examples of portable multifunction devices comprise, without limitation, smart phones and tablets that utilize a plurality of operating systems such as, and without limitation, Windows® and Android®. Other examples of portable multifunction devices comprise, without limitation, virtual reality headsets/systems, laptop or tablet computers. Further, in some examples, Device is a non-portable multifunctional device. Examples of non-portable multifunctional device comprise, without limitation, a desktop computer, a game console, a television, a television set-top box or video and audio streaming devices that connect to a desktop computer, a game console or a television. In some examples, Device includes a touch-sensitive surface (e.g., touch screen displays and/or touchpads). In some other examples, Device includes eye tracker and/or finger tap or a plurality of other body movements or motion sensors. Further, Device optionally comprises, without limitation, one or more other physical user-interface devices, such as a physical or virtual keyboard, a mouse and a joystick.

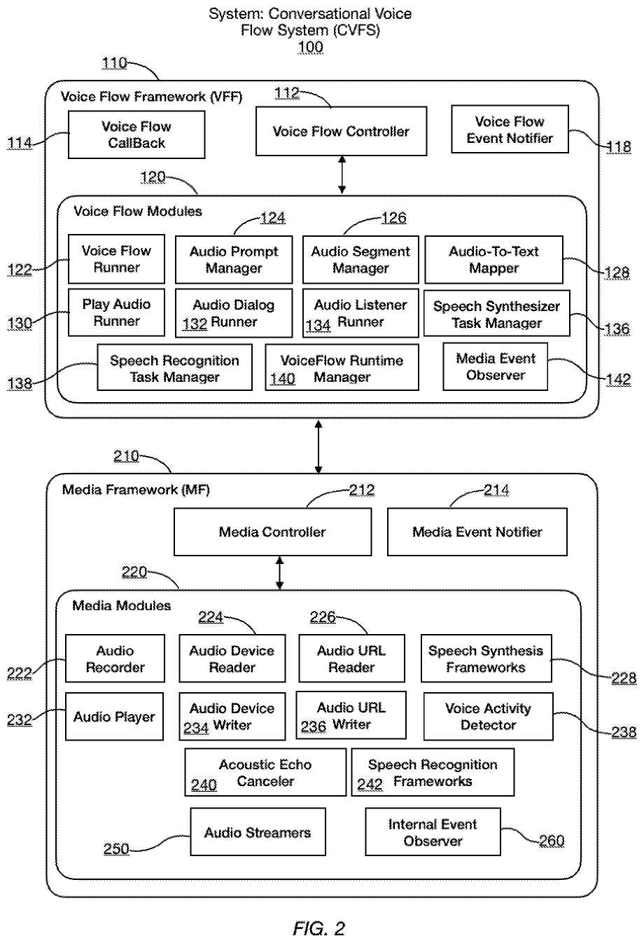

FIG. 2 illustrates the basic modules that VFF 110 and MF 210 comprise. CVFS 100 comprises VFF 110 and MF 210 in accordance with a preferred embodiment example of the present invention. VFF 110 is a front-end framework that loads, interprets and processes VoiceFlows provided by Program or by another VFF 110 client. According to a preferred embodiment example of the present invention, Voice Flow Controller 112 module provides the VFF 110 API interface for Program to integrate and interface with VFF 110. Voice Flow Callback 114 and Voice Flow Event Notifier 118 modules provide Callbacks and event notifications respectively from VFF 110 to Program in accordance with a preferred embodiment of the present invention.

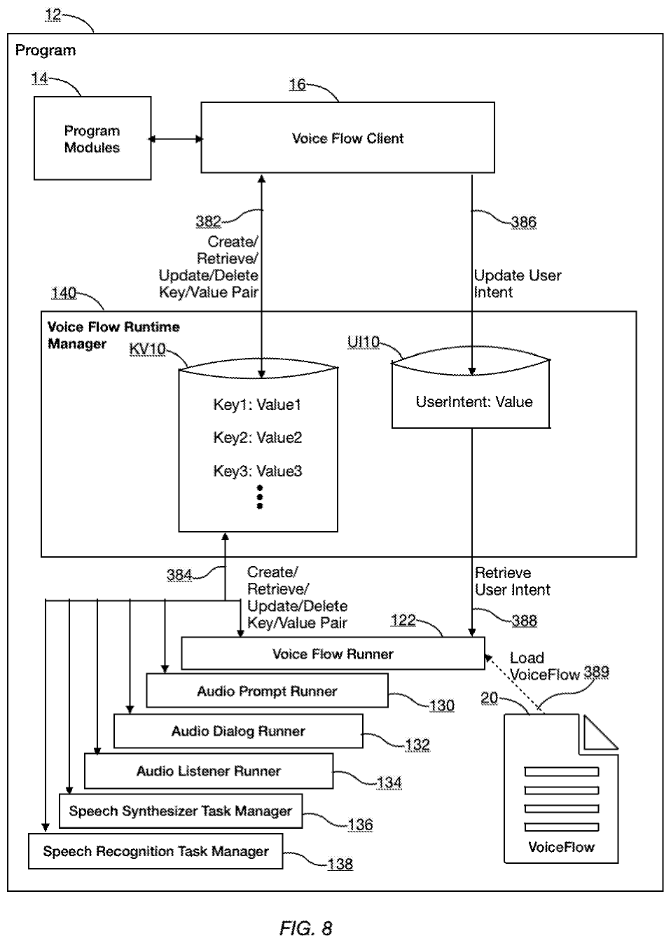

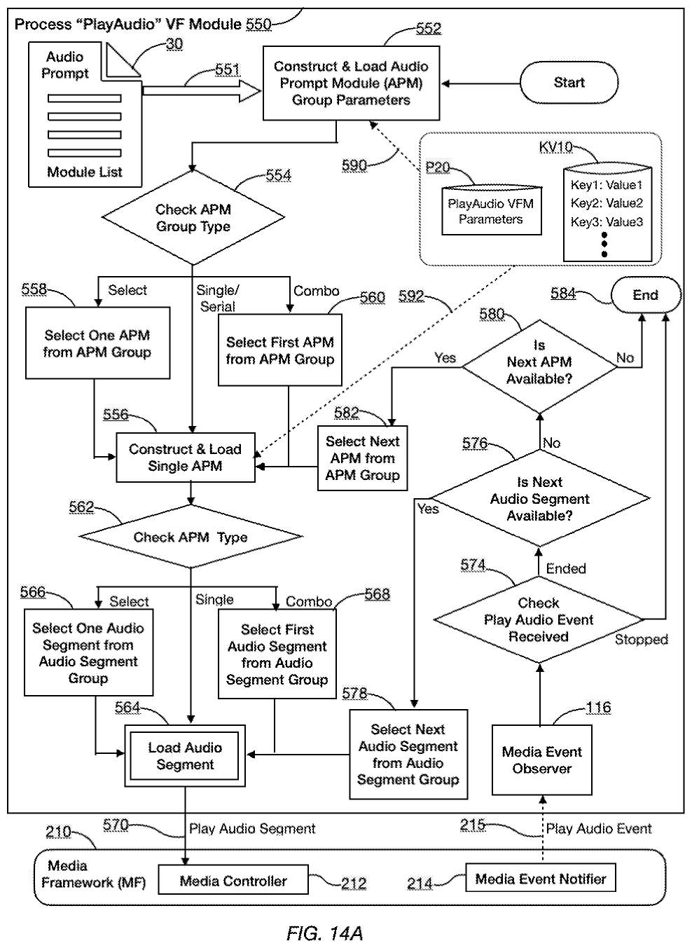

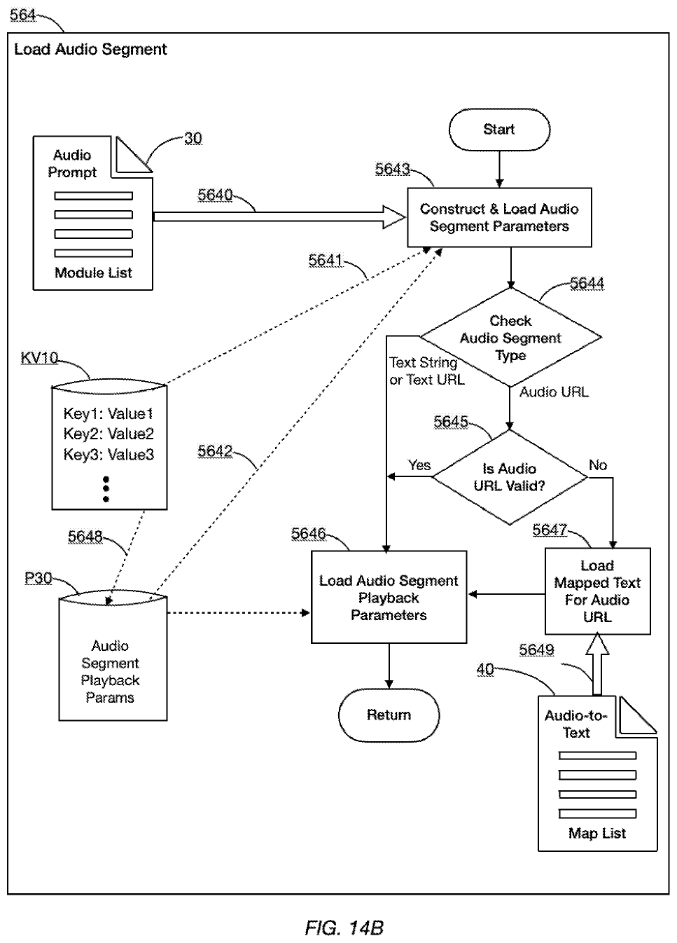

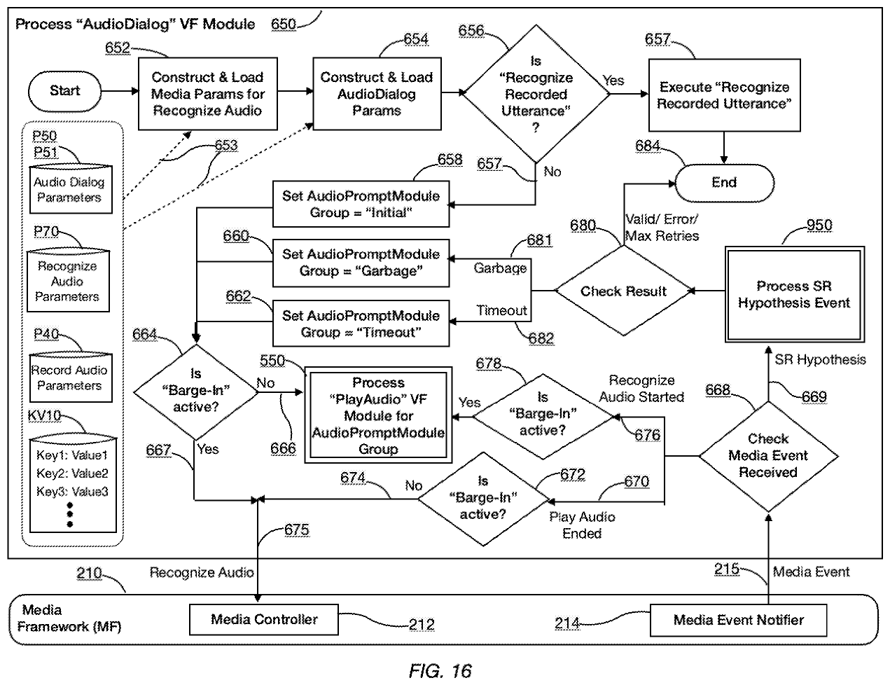

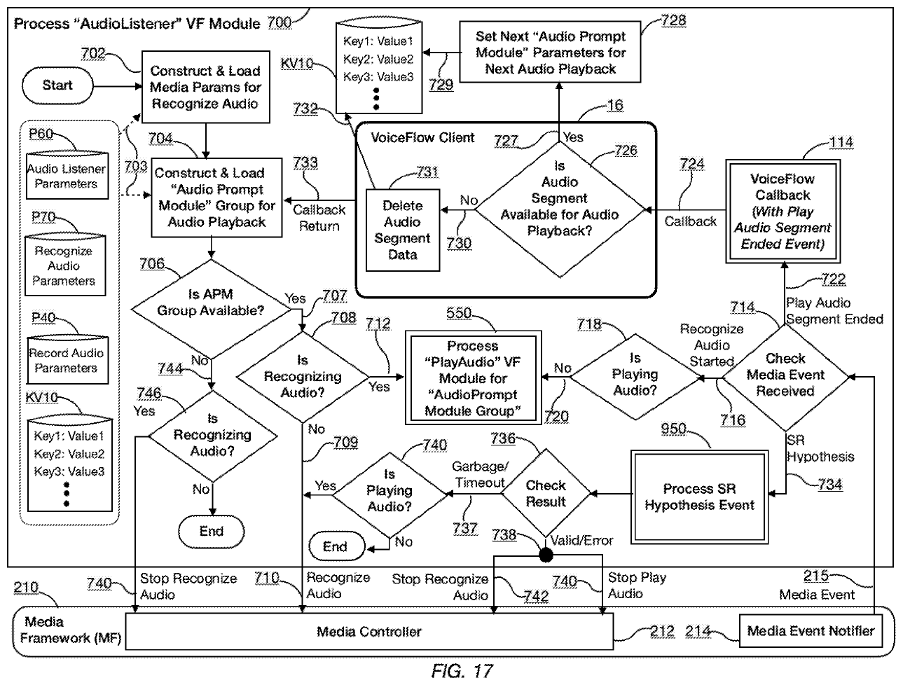

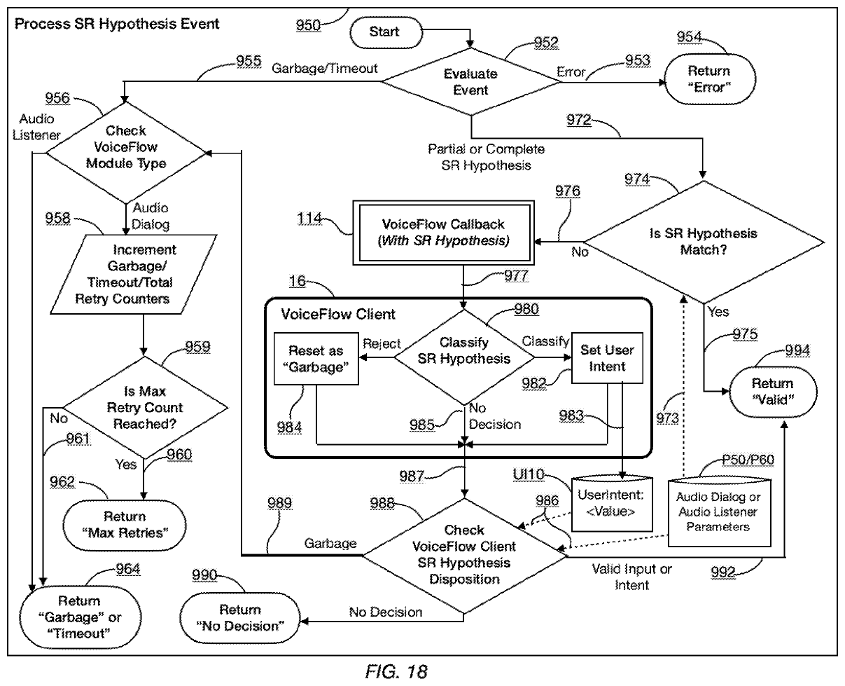

As shown in FIG. 2, VFF 110 comprises a plurality of internal modules to support processing VoiceFlows. In accordance with a preferred embodiment of the present invention, Voice Flow Runner 122 is the main module that manages, interprets and processes VoiceFlows. VoiceFlows are configured with a plurality of VFMs of multiple types which, upon processing, translate to speech-enabled conversational interactions between Program and User. In accordance with a preferred embodiment of the present invention, VFF 110 contains other internal modules comprising: Audio Prompt Manager 124 manages the sequencing of configured APMs to process; Audio Segment Manager 126 translates a configured APM to its individual Audio Segments and corresponding parameters; Audio-To-Text Mapper 128 substitutes raw audio data with configured text to synthesize for various reasons; Audio Prompt Runner 130 manages processing PlayAudio VFMs, as illustrated in FIG. 14A and FIG. 14B; Audio Dialog Runner 132 manages processing AudioDialog VFMs, as illustrated in FIG. 16 and FIG. 18; Audio Listener Runner 134 manages processing AudioListener VFMs, as illustrated in FIG. 17 and FIG. 18; task specific modules, for example 136 and 138; VoiceFlow Runtime Manager 140 allows Program (through Program implementing VFC 16) and Voice Flow Runner 122 to exchange dynamic data during runtime and apply to VoiceFlow active processing which may alter the interaction between Program and User, as illustrated in FIG. 8; and, Media Event Observer 116 listens to real-time media events from MF 210, and translates these events to internal VFF 110 actions and Callbacks.

As shown in FIG. 2, MF 210 is a back-end framework that executes lower-level media tasks requested by VFF 110 or by another MF 210 client. Lower-level media tasks comprise audio playback, audio recording, speech recognition, speech synthesis, speaker device destination changes, etc. In accordance with a preferred embodiment of the present invention, VFF 110 is an MF 210 client interfacing with MF 210. Internally, MF 210 listens to and captures media event notifications, and notifies VFF 110 with these media events. MF 210 provides an API interface and real-time media event notifications to VFF 110. In accordance with a preferred embodiment of the present invention, VFF 110 implements a client component which encapsulates integration with and receiving event notifications from MF 210. According to a preferred embodiment of the present invention, Media Controller 212 module provides a client API interface for VFF 110 to integrate and interface with MF 210. Media Event Notifier 214 module provides real-time event notifications to all MF 210 clients that register with the event notifier of MF 210, for example VFF 110 and VFC 16, in accordance with a preferred embodiment of the present invention.

As shown in FIG. 2, MF 210 comprises a plurality of internal modules to execute media-specific tasks on Device. In accordance with a preferred embodiment of the present invention, MF 210 comprises: Audio Recorder 222 performs recording of raw audio data from a plurality of sources to a plurality of destinations; Audio Device Reader 224 opens an input audio device to read audio data from; Audio URL Reader 226 opens a URL to read or stream audio data from; Speech Synthesis Frameworks 228 is a single or a plurality of Speech Synthesizers that synthesize text to speech audio data; Audio Player 232 performs audio playback of raw audio data from a plurality of sources to a plurality of destinations; Audio Device Writer 234 opens an output audio device to write audio data to; Audio URL Writer 236 opens a URL to write or stream audio data to; Voice Activity Detector 238 detects voice activity in raw audio data and provides related real-time event notifications; Acoustic Echo Canceler 240 cancels acoustic echo, that may be present in recorded audio collected from a Device audio input, generated by simultaneous audio playback on Device audio output on Devices that do not support on-Device acoustic echo cancelation; Speech Recognition Frameworks 242 is a single or a plurality of Speech Recognizers that recognize speech from audio data containing speech; Audio Streamers 250 is a plurality of real-time audio streaming processes that stream raw audio data among MF 210 modules aforementioned; and, Internal Event Observer 260 listens to internal real-time media event notifications from MF 210 modules, and translates these events to internal MF 210 actions.

### 2. Exemplary Architecture of CVFS 100

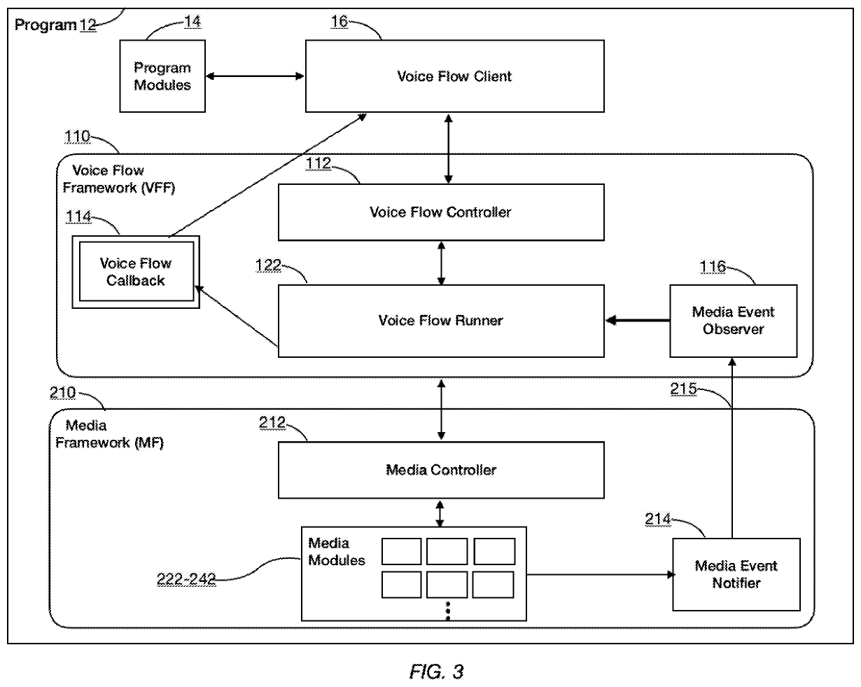

FIG. 3 illustrates a block diagram representing the fundamental architecture, structure and operation of the present invention when included in Program 12 and integrated with to execute speech-enabled conversation interactions for Program 12 and its Program Modules 14, in accordance with various embodiments. According to various embodiments and examples, Program 12 implements VFC 16 to interface with VFF 110 through Voice Flow Controller 112, and to receive Callbacks from VFF 110 through Voice Flow Callback 114. According to various embodiments, Voice Flow Controller 112 instantiates a Voice Flow Runner 122 object to interpret and process VoiceFlows. During VoiceFlow processing, Voice Flow Runner 122 sends real-time event notifications to VFC 16 through Voice Flow Callback 114. According to various embodiments, Voice Flow Runner 122 integrates with MF 210 using Media Controller 212 provided API interface, and receives real-time media event notifications 215 from Media Event Notifier 214 module through Media Event Observer 116. According to various embodiments, Media Controller 212 creates objects of MF 210 modules 222-242 in order to execute lower-level media tasks.

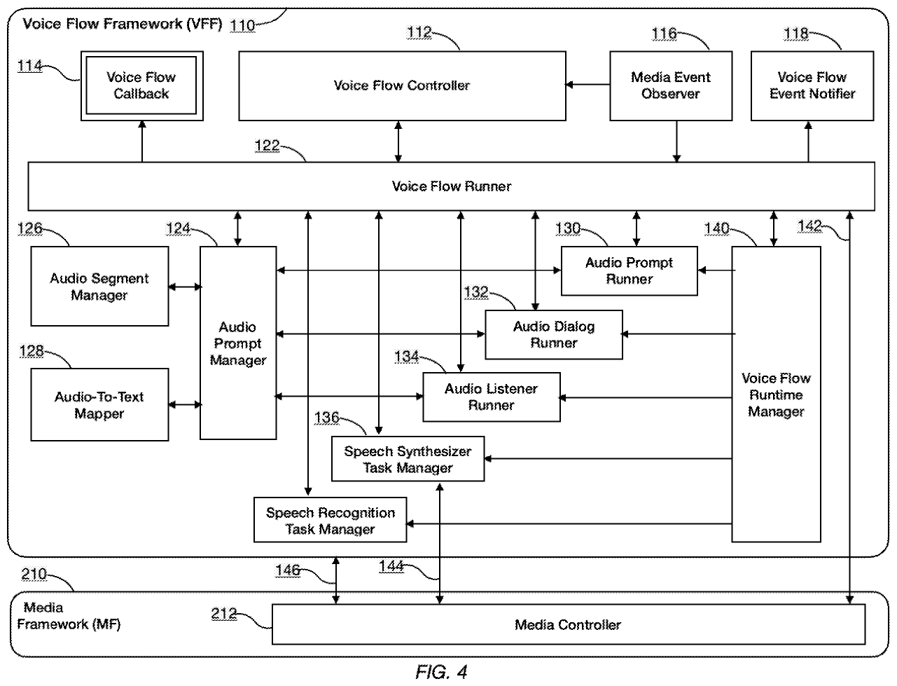

FIG. 4 illustrates a block diagram representing the architecture of VFF 110 according to various embodiments. According to exemplary embodiments, Voice Flow Controller 112 provides the main client API interface for VFF 110. According to an exemplary embodiment of the present invention, Voice Flow Controller 112 creates Voice Flow Runner 122 object to interpret and process VoiceFlows. Voice Flow Runner 122 instantiates other VFF 110 internal modules comprising, but not limited to: Audio Prompt Manager 124, Audio Prompt Runner 130, Audio Dialog Runner 132, Audio Listener Runner 134, Speech Synthesis Task Manager 136, Speech Recognition Task Manager 138 and Voice Flow Runtime Manager 140. VFF 110 internal modules keep track and update runtime variables and processing state of VoiceFlow and VFM processing. While processing a VoiceFlow, Voice Flow Runner 122 communicates with VFF 110 internal modules to update and retrieve their runtime states, and takes action based on those current states. According to various embodiments, Voice Flow Runner 122 calls 142 Media Controller 212 interface in MF 210 to request the execution of lower-level media tasks. Voice Flow Runner 122 communicates back to VFC 16 with Callbacks using Voice Flow Callback 114 and with event notifications using Voice Flow Event Notifier 118. According to various embodiments, VFF 110 internal modules also call Media Controller 212 interface to request the execution of lower-level media tasks, as illustrated at 144 for Speech Synthesis Task Manager 136 and at 146 for Speech Recognition Task Manager 138. According to various embodiments, during VoiceFlow processing, VFC 16 provides updates to dynamic runtime parameter values stored in Voice Flow Runtime Manager 140 by calling Voice Flow Controller 112 interface which passes the parameters and values through Voice Flow Runner 122 to Voice Flow Runtime Manager 140. Voice Flow Runtime Manager 140 provides these dynamic runtime variable values to Voice Flow Runner 122 and to VFF 110 internal modules when needed during VoiceFlow processing. Similarly, during VoiceFlow processing, Voice Flow Runner 122 provides updates to dynamic runtime parameter values stored at Voice Flow Runtime Manager 140. VFC 16 retrieves these parameter and values from Voice Flow Runtime Manager 140 by calling Voice Flow Controller 112 interface which retrieves the parameters and values from Voice Flow Runtime Manager 140 through Voice Flow Runner 122. According to various embodiments, Audio Prompt Manager 124 communicates with Audio Segment Manager 126 and Audio-To-Text Mapper 128 to construct Audio Segments for processing at runtime and to keep track of APM and Audio Segment execution sequence. According to various embodiments, Media Event Observer 116 receives real-time media event notifications from MF 210 and provides these notifications to Voice Flow Controller 112 for processing.

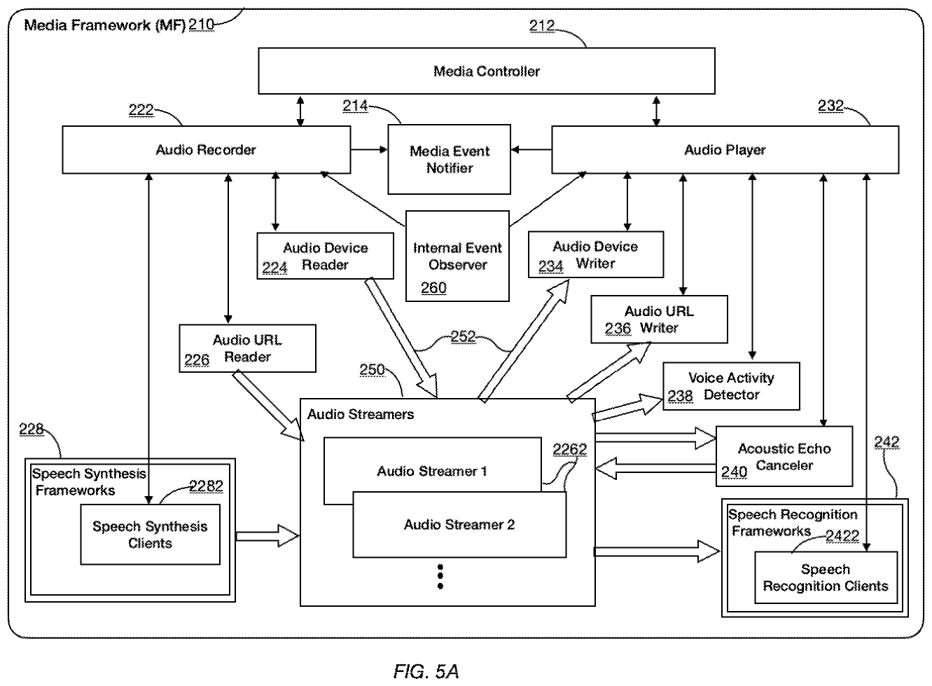

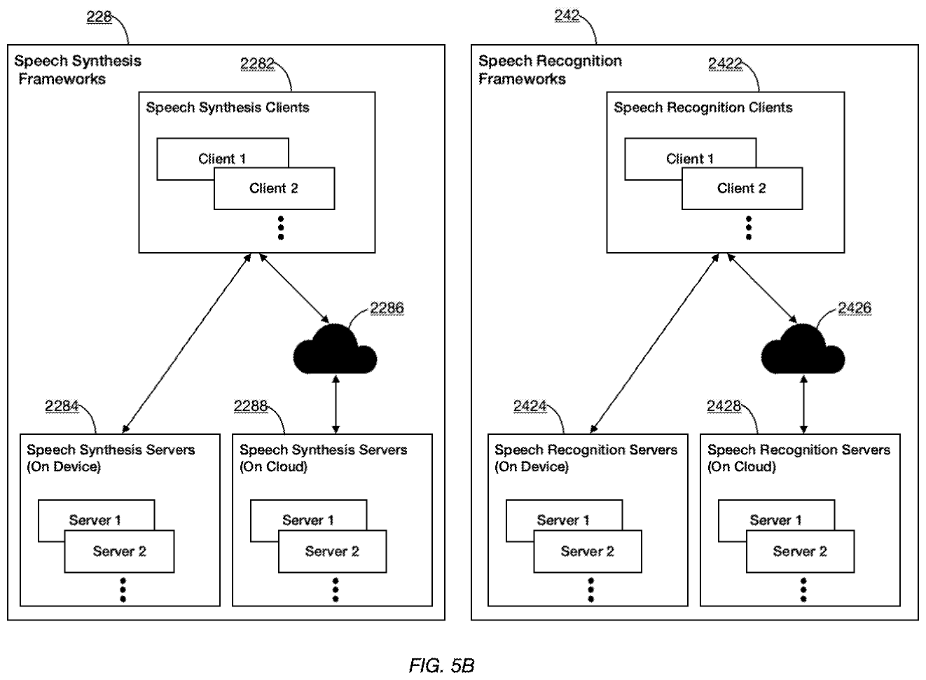

FIG. 5A illustrates a block diagram representing the architecture of MF 210 according to various embodiments. According to exemplary embodiments, Media Controller 212 provides the client API interface for MF 210. According to an exemplary embodiment of the present invention, Media Controller 212 creates Audio Recorder 222 and Audio Player 232 objects. Audio Recorder 222 creates Audio Device Reader 224 and Audio URL Reader 226 objects, and instantiates a single or a plurality of Speech Synthesis Frameworks 228. According to various embodiments, as illustrated in FIG. 5B, Speech Synthesis Frameworks 228 implement Speech Synthesis Clients 2282 which interface with Speech Synthesis Servers 2284 running on Device and/or with Speech Synthesis Servers 2288 running on Cloud 2286 and accessed through a Software as a Service (hereafter “SaaS”) model in accordance with various examples. According to various embodiments, Audio Player 222 creates Audio Device Writer 234, Audio URL Writer 236, Voice Activity Detector 238 and Acoustic Echo Canceler 240 objects, and instantiates a single or a plurality of Speech Recognition Frameworks 242. According to various embodiments, as illustrated in FIG. 5B, Speech Recognition Frameworks 242 implement Speech Recognition Clients 2422 which interface with Speech Recognition Servers 2424 running on Device and/or with Speech Recognition Servers 2428 running on Cloud 2426 and accessed through SaaS in accordance with various examples. According to various embodiments, a plurality of Audio Streamers 250 stream raw audio data 252 among MF 210 internal modules as illustrated in FIG. 5A. According to various embodiments, Internal Event Observer 260 listens and receives internal media event notifications from MF 210 internal modules during the execution of media tasks. Internal Event Observer 260 passes these notifications to Audio Recorder 222 and Audio Player 232 for processing. Audio Recorder 222 and Audio Player 232 generate media event notifications for clients of MF 210. According to various embodiments of the present invention, MF 210 sends these media event notifications to VFF 110, VFC 16 and any other MF 210 clients that register with Media Event Notifier 214 to receive media event notifications from MF 210.

### 3. Exemplary Functionality of CVFS 100

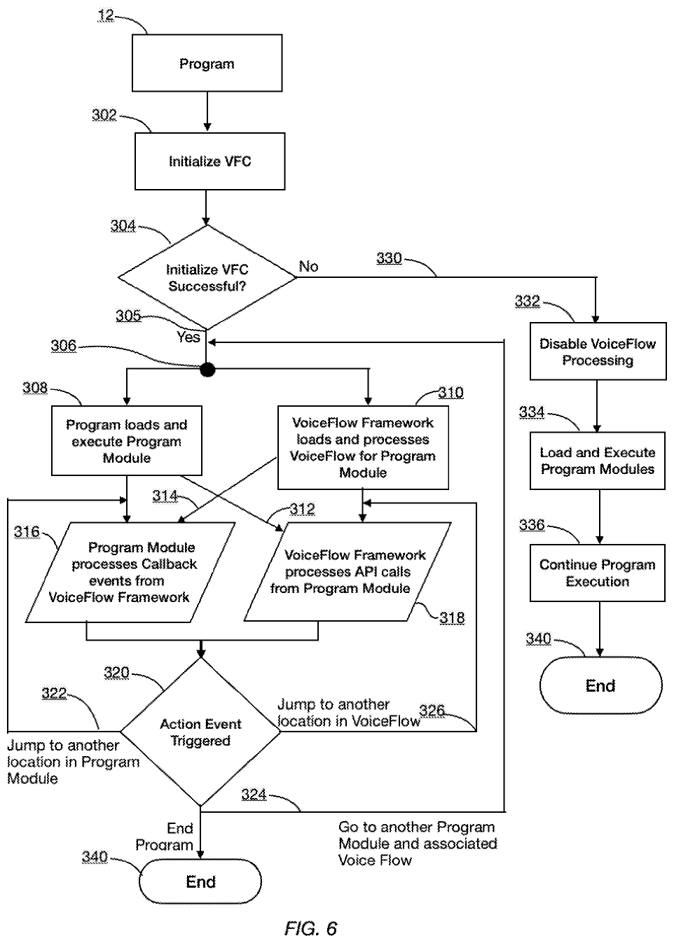

FIG. 6 illustrates a block diagram for Program 12 executing while also interfacing with VFF 110 and requesting VFF 110 to process a VoiceFlow. In some embodiments, Program 12 initializes 302 VFC 16. If VFC 16 initialization 304 result is not successful 330, Program 12 disables VoiceFlow processing 332 and proceeds to execute its functionalities without VoiceFlow processing support, such as, according to various examples and without limitation, loading and executing its Program Modules 334, and continuing with Program execution 336 until Program 12 ends 340. If VFC 16 initialization result is successful 305, according to various embodiments, Program 12 executes, concurrently 306, two processes: Program 12 loads and executes Program Module 308, and Program 12 submits a VoiceFlow, associated with Program Module being executed, to VFF 110 for VFF 110 to load and process 310. According to various examples, Program Module listens to Callbacks 316 from VFF 110 through VFC 16, and VFF 110 processes API calls 318 from Program Module being executed. According to various examples, 312 represents VFC 16 creating, retrieving, updating and deleting (hereafter “CRUD”) dynamic data at runtime for VFF 110 to process and 314 represents VFF 110 CRUD dynamic runtime data for VFC 16 to process. According to various examples, event notifications from VFF 110 and dynamic runtime data CRUD by VFF 110 are processed by VFC 16 which may alter Program 12 execution. According to various examples, VFC 16 API calls to VFF 110 and dynamic runtime data CRUD by Program 12 are processed by VFF 110 which may result with VFF 110 altering its VoiceFlow execution. According to various examples, event notifications from VFF 110, and VFC 16 calling VFF 110 interface during VoiceFlow processing, may trigger a plurality of actions 320 for both Program 12 execution and VoiceFlow processing, comprising, but not limited to: Program 12 moves execution of Program Module to another location in Program Module 322 or to a different Program Module 324 to execute; VFF 110 moves VoiceFlow processing to a different VFM in VoiceFlow 326; Program 12 interrupts/stops VoiceFlow processing while it continues to execute (not shown in FIG. 6); Program 12 ends 340.

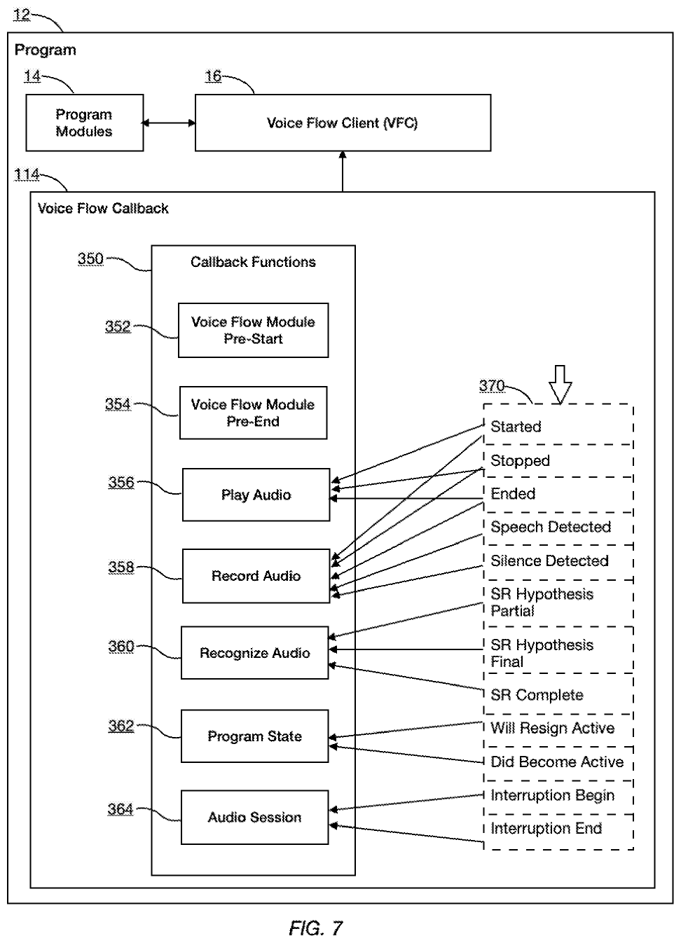

FIG. 7 illustrates a block diagram for Callbacks to VFC 16, according to various embodiments. During Program 12 execution with VoiceFlow processing enabled, and according to various examples, Program 12 receives input from VFF 110 using many methodologies comprising, but not limited to, Callbacks and event notifications. For Callbacks, and in accordance with various examples, Program 12 processes a plurality of these Callbacks and adjusts its execution accordingly to keep User informed and engaged while providing User best and adaptive User experience. According to various embodiments, VFF 110 performs Callbacks for a plurality of Functions 350 with associated Media Events 370 accompanied with related data and statistics to Program 12 and Program Modules 14 through VFC 16 comprising: VFM pre-start 352 and VFM pre-end 354 processing functions; Play Audio 356 comprising media events “Started”, “Stopped” or “Ended” with audio timestamp data; Record Audio 358 comprising media events “Started”, “Stopped”, “Ended”, “Speech Detected” or “Silence Detected” with audio timestamp data; Recognize Audio 360 comprising media events “SR Hypothesis Partial”, “SR Hypothesis Final”, or “SR Complete” with SR confidence levels and other SR statistics; Program State 362 comprising media events “Will Resign Active” or “Will Become Active”; and Audio Session 364 comprising media events “Interruption Begin” or “Interruption End”. According to various examples, Program 12 CRUDs dynamic runtime data during its processing of these Callbacks. According to various examples but without limitation, Program 12 switches from executing one Program Module 14 to executing another upon receiving a “Recognize Audio” Callback function 360 with valid speech recognition hypothesis that Program 12 classifies to require Program 12 to conduct such action. According to Various examples, after an audio session interruption to Program 12 and to its VoiceFlow processing, Program 12 may instruct VFF 110 to resume VoiceFlow processing at a specific VFM during an “Audio Session” Callback Function 364 with an “Interruption End” media event value.

FIG. 8 illustrates a block diagram for CRUD dynamic runtime parameters by Program 12 and Program Modules 14 through VFC 16 and by VFF 110 during VoiceFlow processing, according to various embodiments. According to various embodiments, dynamic runtime parameters are parameters that are declared and referenced in VoiceFlow 20 and/or are internal VFF 110 parameters exposed to VFF 110 clients to access. Both VFF 110 and VFC 16 have the ability to create, retrieve, update and delete (hereafter also “CRUD”) dynamic runtime parameters declared and referenced in VoiceFlow 20 during VoiceFlow processing. According to various examples, during VoiceFlow processing by VFF 110, VFC 16 calls VFF 110 interface to CRUD 382 dynamic runtime parameters. According to various examples, during VFF 110 Callback to VFC 16, VFC 16 CRUDs 382 dynamic runtime parameters by calling VFF 110 interface prior to returning Callback to VFF 110. According to various embodiments, Voice Flow Runtime Manager 140 manages the CRUD of dynamic runtime parameters using many methodologies including, but without limitation, utilization of Key/Value pairs KV10, where Key is a parameter name and Value is a parameter value that is of type selected from a plurality of types comprising Integer, Boolean, Float, String etc. According to various examples, VFC 16 CRUDs 382 dynamic runtime parameters through Voice Flow Runtime Manager 140 by calling VFF 110 interface. Similarly, VFF 110 internal modules 122, 130, 132, 134, 136 and 138 CRUD 384 dynamic runtime parameters through Voice Flow Runtime Manager 140.

FIG. 8 also illustrates VFC 16 updating User intent (UserIntent) UI10 after Program Module 14 processes and classifies a recognized User utterance (SR Hypothesis) to a valid User intent during Callback with “Recognize Audio” function 360 illustrated in FIG. 7 with either “SR Hypothesis Partial” or “SR Hypothesis Final” media event value 370 illustrated in FIG. 7. According to various embodiments, UserIntent UI10 is an example of a VFF 110 internal dynamic runtime parameter updated and deleted by VFC 16 during VoiceFlow processing through an interface call 386 to VFF 110, and retrieved 388 by Voice Flow Runner 122 during the processing of AudioDialog and AudioListener VFMs. According to various examples, Voice Flow Runner 122 compares 389 value of UserIntent against User intents configured in VoiceFlow 20, and if a match is found, VoiceFlow processing continues following the rules configured in VoiceFlow 20 for matching that UserIntent.

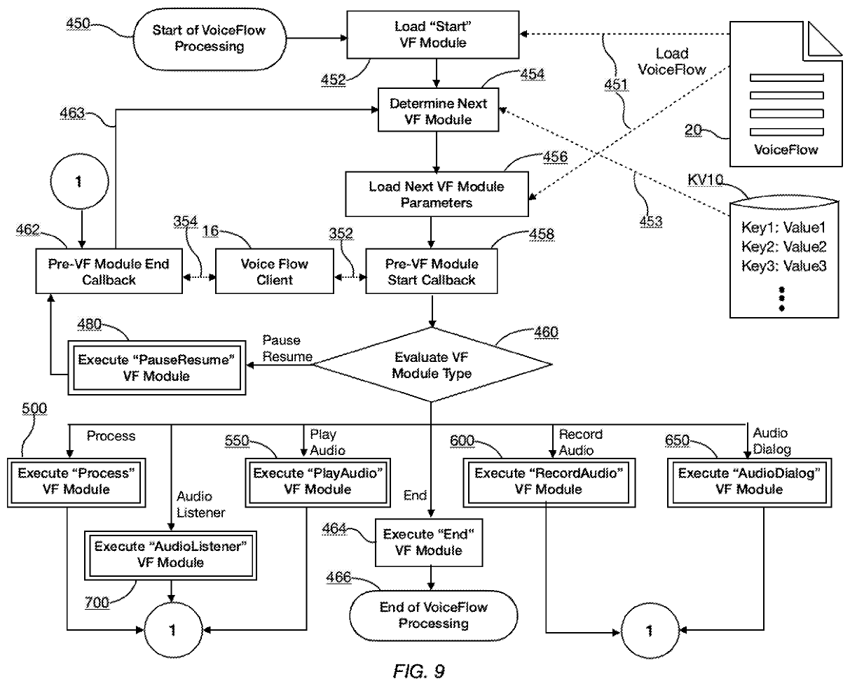

FIG. 9 illustrates a block diagram for VFF 110 processing 451 a VoiceFlow 20 based on Program providing VoiceFlow 20 to VFF 110 through VFC 16 calling VFF 110 interface, according to various embodiments. According to various embodiments, VFF 110 starts VoiceFlow processing by searching for and processing a singular “Start” VFM 452 configured in VoiceFlow 20. According to various embodiments, VFF 110 determines from current VFM configuration the next VFM to transition to 454, which may require retrieving 453 dynamic runtime parameter values from KV10. VFF 110 proceeds to load next VFM configuration 456 from 451 VoiceFlow 20. According to various embodiments, VFF 110 performs a “VFM Pre-Start” function (352 illustrated in FIG. 7) Callback 458 to VFC 16, then proceeds to process the VFM starting with evaluation of VFM type 460. According to various embodiments, VFF 110 processes VFMs of the following types, but not limited to, “PauseResume” 480, “Process” 500, “PlayAudio” 550, “RecordAudio” 600, “AudioDialog” 650 and “AudioListener” 700. Exemplary functionalities of processing each of these VFM types are described later. According to various embodiments, VFF 110 ends its VoiceFlow execution 466 if next VFM is an “End” VFM 464. According to various embodiments, at the end of a VFM processing and before unloading the VFM, VFF 110 performs a “VFM Pre-End” function (354 illustrated in FIG. 7) Callback 462 to VFC 16, then proceeds 463 to determine next VFM to transition to 454.

### 4. Processing Client Interruptions

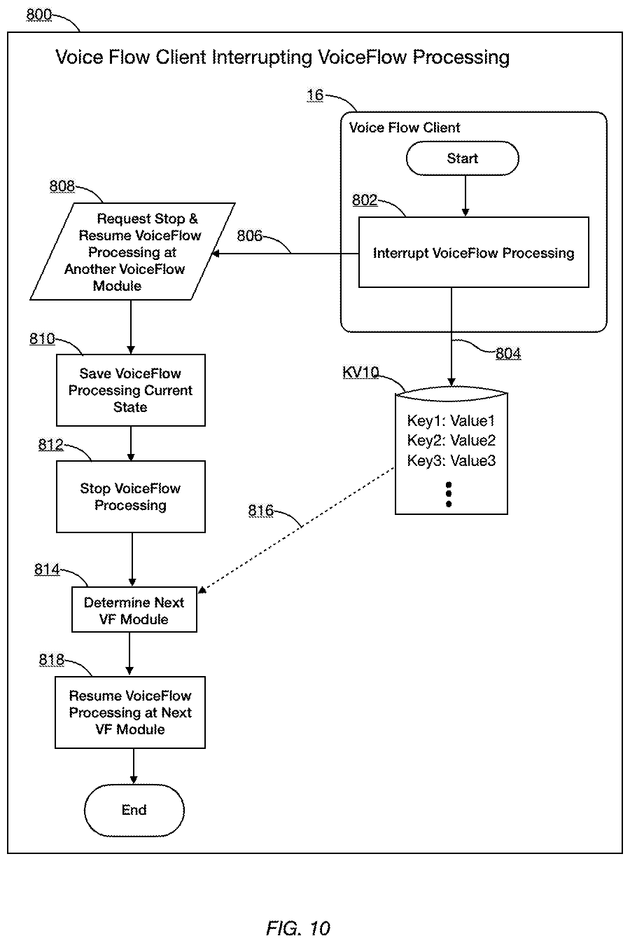

FIG. 10 illustrates a block diagram 800 showing VFF 110 processing an interruption to its VoiceFlow processing received from VFC 16 implemented by Program 12, according to various embodiments. According to various examples, Program 12 instructs VFC 16 to request a VoiceFlow processing interruption 802. According to various examples, VFC 16 CRUDs dynamic runtime parameters KV10 through an interface call 804 to VFF 110. Following that, VFC 16 makes another interface call 806 to VFF 110 requesting an interruption to VoiceFlow processing and a transition to another VFM for processing 808. According to various embodiments, VFF 110 saves VoiceFlow processing current state 810, stops VoiceFlow Processing 812, determines next VFM to process 814 with possible dependency 816 on dynamic runtime parameter values KV10 and resumes processing VoiceFlow processing at next VFM 818.

### 5. Processing Audio Session Interruptions

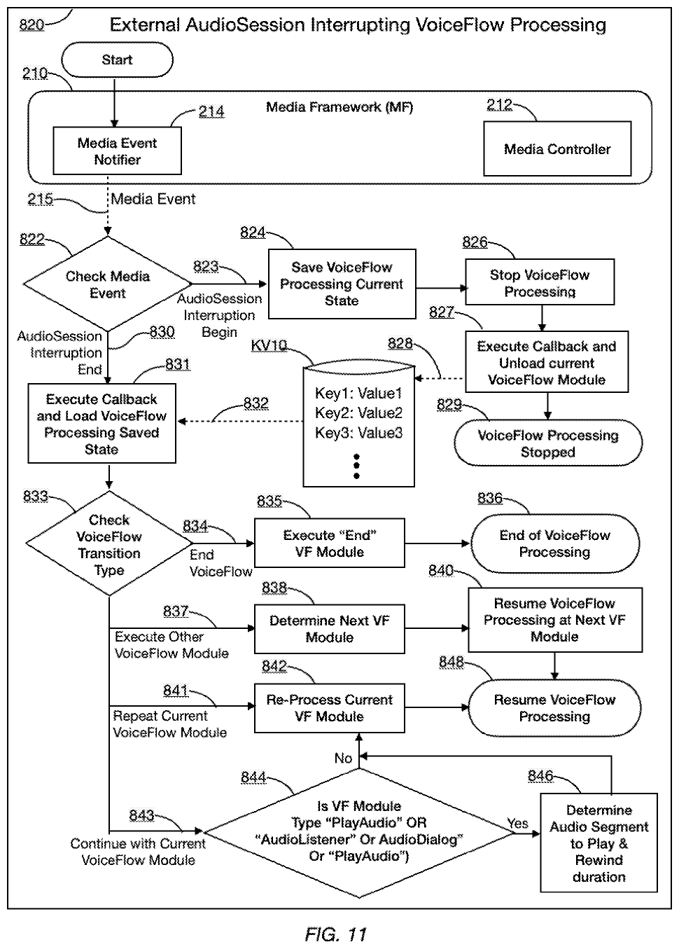

FIG. 11 illustrates a block diagram 820 showing VFF 110 processing Audio Session interruption event notifications to its VoiceFlow processing received from an external Audio Session on Device, according to various embodiments. According to various embodiments, Internal Event Observer 260 (shown in FIG. 5A) in MF 210 receives Audio Session interruption event notifications on Device generated by another program executing on Device. According to various embodiments, Media Event Notifier 214 in MF 210 posts Audio Session interruption media events 215 to MF 210 clients. VFF 110 receives and evaluates these media event notifications 822. If media event is “AudioSession Interruption Begin” 823, VFF 110 saves VoiceFlow processing current state 824, stops processing current VFM 826, makes a Callback 827 to VFC 16 with an “Audio Session” function 364 (364 shown in FIG. 7) and with media event “Interruption Begin” listed in 370 (370 shown in FIG. 7). According to various examples, VFC 16 CRUDs 828 dynamic runtime parameters KV10 prior to returning the Callback to VFF 110. VFF 110 then unloads 827 the current VFM and completes stopping VoiceFlow processing 829. According to various embodiments, when 822 evaluates media event to be “AudioSession Interruption End” 830, VFF 110 makes a Callback 831 to VFC 16 with an “Audio Session” function 364 and with media event “Interruption End” listed in 370, and loads VoiceFlow saved state with optional dependency 832 on dynamic runtime parameters KV10. VFF 110 evaluates 833 the default configured VoiceFlow processing transition or the VoiceFlow processing transition updated by VFC 16 at 828: if the transition evaluates to “End VoiceFlow” 834, VFF 110 processes “End” VFM 835 and ends VoiceFlow processing 836; if the transition evaluates to “Execute other VoiceFlow Module” 837, VFF 110 determines next VFM to process 838 and resumes VoiceFlow processing 848 at that VFM 840; if the transition evaluates to “Repeat Current VoiceFlow Module” 841, VFF 110 re-processes current VFM 842 and resumes VoiceFlow processing 848; or, if transition evaluates to “Continue with Current VoiceFlow Module” 843, VFF 110 checks type of current VFM 844, if VFM type is “AudioDialog” or “AudioListener” or “PlayAudio”, VFF 110 determines Audio Segment for audio playback and time duration to rewind the audio playback for the Audio Segment 846 selected, continues to re-process the current VFM 842 from Audio Segment determined and resumes VoiceFlow Processing 848, or, If VFM type is not “AudioDialog” and not “AudioListener” and not “PlayAudio”, VFF 110 re-processes current VFM 842 and resumes VoiceFlow processing 848.

### 6. Processing PauseResume VFM

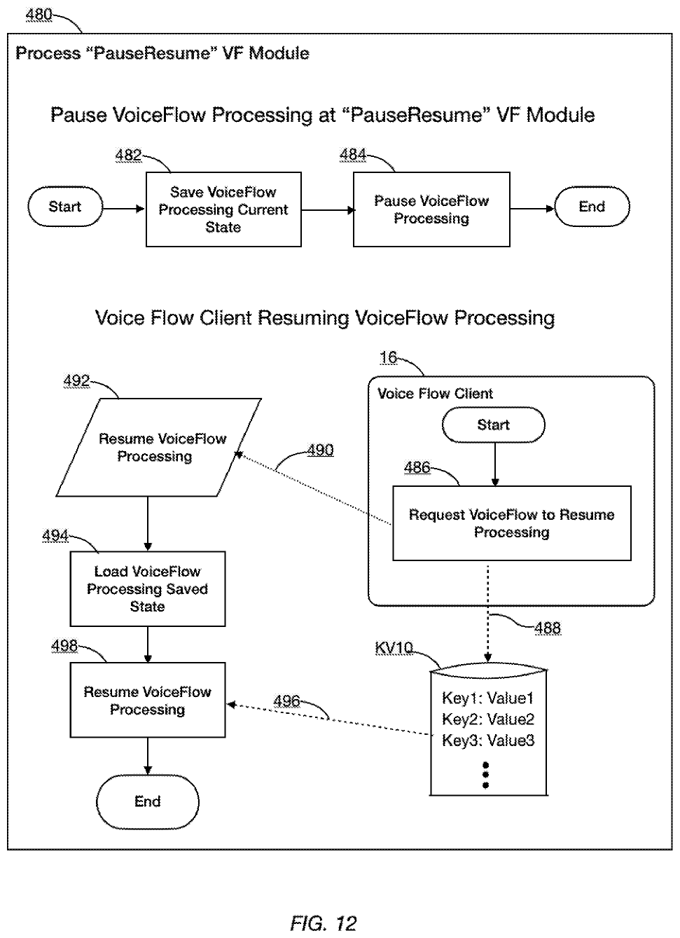

FIG. 12 illustrates a block diagram of VFF 110 processing a PauseResume VFM 480 as configured in a VoiceFlow in accordance with various embodiments. When VFF 110 loads and processes a PauseResume VFM, VFF 110 pauses VoiceFlow processing until Program 12 requests VFF 110, through VFC 16 and according to various examples, to resume VoiceFlow processing. According to various examples, a PauseResume VFM allows User to enter a password using a secure input mode instead of User speaking the password. After User enters password securely, Program 12 requests VFF 110, through VFC 16, to resume VoiceFlow Processing. According to various embodiments, VFF 110 saves current Voice Flow processing state 482 before it pauses VoiceFlow processing 484. According to various examples, Program 12 decides that VoiceFlow processing resumes 486 resulting with VFC 16 CRUDs dynamic runtime parameters KV10 through an interface call 488 to VFF 110 followed by VFC 16 making an interface call 490 to VFF 110 requesting VoiceFlow processing to resume 492. According to various embodiments, VFF 110 loads saved VoiceFlow State 494, retrieves 496 dynamic runtime parameters KV10 and resumes VoiceFlow processing 498 at that VFM.

The following table 1 shows a JSON example of PauseResume VFM for processing.

TABLE 1

| | | |
|---|---|---|
| 1 | { | |
| 2 | ″id″: ″1025_PauseResume″, | ← ID of VFM - Passed to client during |
| | | Callbacks. |
| 3 | ″type″: ″pauseResume″, | ← Type of VFM: “pauseResume”. |
| 4 | ″name″: ″ResumeAfterAppRequest″, | ← Descriptive VFM name. |
| 5 | ″goTo″: { | ← Specifies VFMs to transition to after |
| | | this VFM resumes and completes |
| | | processing. |
| 6 | ″DEFAULT″: ″1025_EnableSpeaker″, | ← Specifies default VFM ID to transition |
| 7 | | to. |
| 8 | }, | |
| 9 | }, | |

### 7. Processing Process VFM

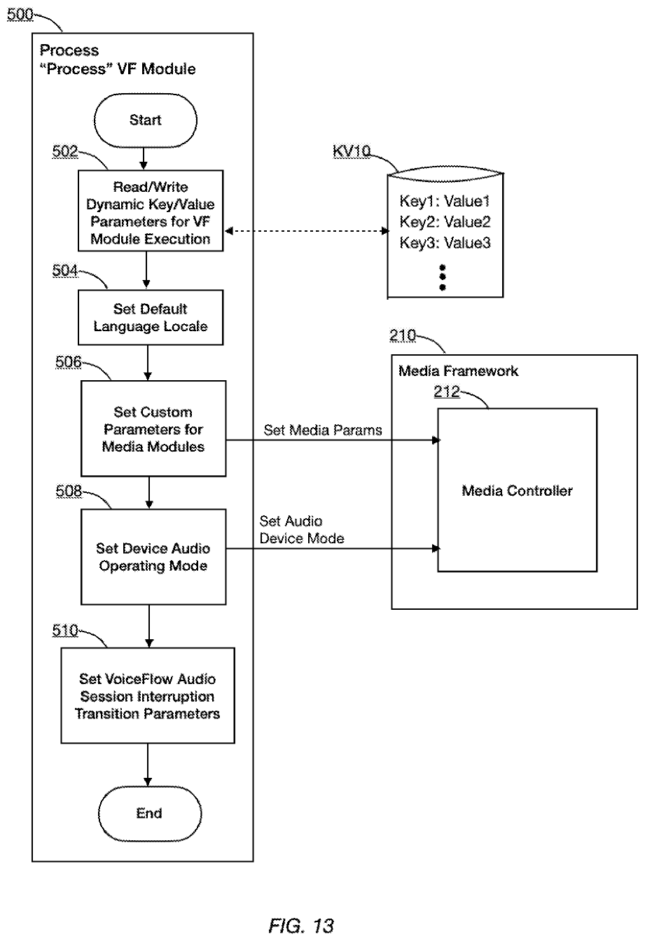

FIG. 13 illustrates a block diagram of VFF 110 processing a Process VFM 500 as configured in a VoiceFlow in accordance with various embodiments. According to various embodiments, a Process VFM is a non-User interactive VFM. It is predominantly used to, but not limited to: CRUD 502 dynamic runtime parameters KV10; set default Language Locale to use for interaction with User 504; set custom parameters 506 for media modules and frameworks in MF 210 through interface requests to Media Controller 212; set Device audio operating mode 508; and/or, set default Audio Session interruption transition parameters 510.

The following table 2 shows a JSON example of Process VFM for processing.

TABLE 2

| | | |
|---|---|---|
| 1 | { | |
| 2 | ″id″: ″1026_Process_EntryModule″, | ← ID of VFM - Passed to client |
| | | during Callbacks. |
| 3 | ″type″: ″process″, | ← Type of VFM: “process”. |
| 4 | ″name″: ″Entry Module Process VFM″, | ← Descriptive VFM name. |
| 5 | ″processParams″: { | ← Specifies parameters to process. |
| 6 | ″langLocale″: ″en-US″, | ← Specifies the language locale to |
| | | be US English. |
| 7 | ″speakerEnabled″: false, | ← Program uses Device external |
| | | speaker. |
| 8 | ″keyValuePairCollection″: [ | ← Key Value Pair collection to |
| | | create |
| 9 | { | |
| 10 | ″key″: ″$[WhatToChatAbout]″, | ← Key is “WhatToChatAbout” |
| 11 | ″value″: ″VFM_WhatToChatAbout″, | |
| | | ← Value is |
| 12 | }, | “VFM_WhatToChatAbout” |
| 13 | { | |
| 14 | ″key″: ″$[EnableShutdownMode]″, | |
| 15 | ″value″: true, | ← Key is “EnableShutdownMode” |
| 16 | }, | ← Value is true. |
| 17 | ], | |
| 18 | ″SSCustomLexicon″: { | |
| | | ← Custom Lexicon parameters for |
| 19 | ″loadCustomLexicon″: true, | Speech Synthesizer. |
| | | ← Loading custom lexicon is |
| 20 | }, | enabled |
| 21 | }, | |
| 22 | | |
| | ″goTo″: { | ← Specifies VFMs to transition to |
| 23 | | after VFM completes processing. |
| 24 | ″DEFAULT″: ″1027_PlayAudio_Start″, | ← Specifies default VFM ID to |
| 25 | }, | transition to. |
| | }, | |

### 8. Processing PlayAudio VFM

FIG. 14A and FIG. 14B illustrate block diagrams of VFF 110 processing a PlayAudio VFM 550 as configured in a VoiceFlow, which when processed by VFF 110, results in audio playback by Program on Device to User, according to various embodiments of the present invention.

According to various examples and embodiments, a PlayAudio VFM is configured to retrieve raw audio from a plurality of recorded audio files or from a plurality of URLs, local to Device or accessible over, but not limited to, network, internet or cloud, or a combination thereof, and to send or stream the raw audio to output audio devices including, but not limited to, Device internal or external speakers, or Device Bluetooth audio output. According to various examples and embodiments, a PlayAudio VFM is configured to retrieve raw audio recorded from a Speech Synthesizer or a plurality of speech synthesizers, local to Device or accessible over, but not limited to, network, internet or cloud, or a combination thereof, and to send or stream the raw audio to output audio devices including, but not limited to, Device internal or external speakers, or Device Bluetooth audio output. According to various examples and embodiments, a PlayAudio VFM is configured to retrieve raw audio from a combination of a plurality of sources comprising recorded audio files, URLs, speech synthesizers and/or network-based audio stream sources, and to send or stream the raw audio to output audio devices including, but not limited to, Device internal or external speakers, or Device Bluetooth audio output.

According to various examples and embodiments, a PlayAudio VFM is configured to process an APM or an Audio Prompt Module Group (hereafter “APM Group”), which references a single APM or a plurality of APMs configured in Audio Prompt Module List 30 (shown in FIG. 14A). Each APM is further configured in Audio Prompt Module List 30 to reference a single Audio Segment, another single APM or a plurality of APMs. The embodiment illustrated in FIG. 14A does not show processing a PlayAudio VFM configured to reference a single APM and does not show processing of an APM referencing other APMs. It is to be understood that other examples illustrations can be made to show PlayAudio VFM processing a single APM and processing and APM referencing other APMs.

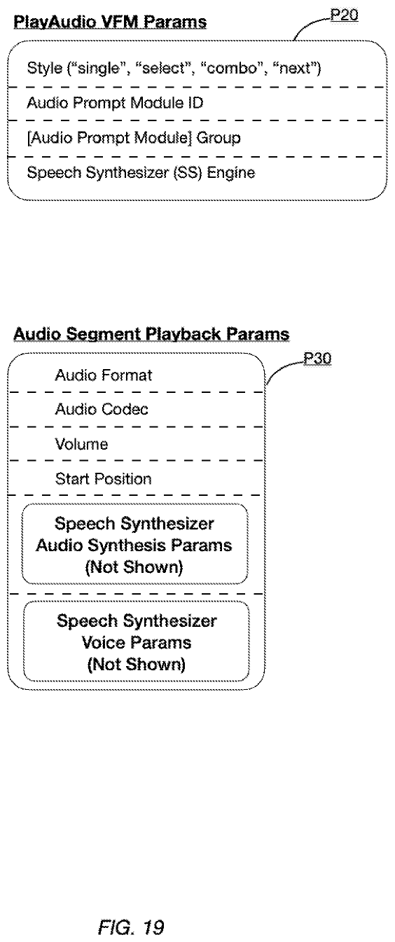

With reference to FIG. 14A, in some embodiments, processing a PlayAudio VFM starts with constructing and loading APM Group parameters 552 from multiple sources: PlayAudio VFM Parameters P20 (illustrated in FIG. 19) configured in PlayAudio VFM (VFM configured in VoiceFlow 20) and retrieved through 590; APM and Audio Segment parameters configured in Audio Prompt Module List 30 retrieved through 551; and dynamic runtime parameters KV10 retrieved through 590.

With reference to FIG. 14A and according to various examples and embodiments, a PlayAudio VFM is configured to process APMs referenced in an APM Group according to the configured type of the APM Group 554, which include, and without limitation:
APM Group of type “single”: processing only first APM configured in APM Group 556.
APM Group of type “serial”: processing only next single APM selected serially from APM Group 556 during run time. According to various examples, during a dialog interaction with User, processing an APM Group of type “serial” to execute audio playback for every “speech timeout” encountered from User results in next APM selected serially from the APM Group to be processed for audio playback to User.
APM Group of type “select”: processing only one APM selected randomly from APM Group 558 at runtime. According to various examples, this allows one or a plurality of APMs, to be selected randomly and processed for audio playback to User in order to avoid redundancy of same audio playback to User.
APM Group of type “combo”: processing all APMs serially in APM Group for a single collective audio playback 560.

With reference to FIG. 14A, in some embodiments, constructing and loading an APM 556 requires parameters from multiple sources: PlayAudio VFM Parameters P20 (illustrated in FIG. 19) configured in PlayAudio VFM and retrieved through 592; APM and Audio Segment parameters configured in Audio Prompt Module List 30 (retrieved through 551 not shown in FIG. 14A); and dynamic runtime parameters KV10 retrieved through 592.

With reference to FIG. 14A and according to various examples and embodiments, a PlayAudio VFM is configured to process Audio Segments configured in APMs according to the configured type of the APM 562, which include, and without limitation:
APM of type “single”: processing only first Audio Segment selected at run time 564.
APM of type “select”: processing only one Audio Segment selected randomly 566 from a list of configured Audio Segments. According to various examples, this allows one of a plurality of Audio Segments, to be selected randomly and processed at runtime to avoid redundancy of same audio playback to User.
APM of type “combo”: processing all Audio Segments in APM serially 568 for a single collective audio playback.

With reference to FIG. 14A and FIG. 14B, in some embodiments, loading an Audio Segment 564 during processing of a PlayAudio VFM requires constructing and loading Audio Segment parameters 5643 from multiple sources: APM parameters configured in Audio Prompt Module List 30 retrieved through 5640; Audio Segment Playback parameters P30 (illustrated in FIG. 19) configured in Audio Prompt Module List 30 for the referenced Audio Segment and retrieved through 5642; and dynamic runtime parameters KV10 retrieved through 5641.

With reference to FIG. 14A and according to various embodiments, Audio Segments are configured to have multiple types comprising, and not limited to, “audio URL”, “text URL” or “text string”. Audio Segment with “audio URL” type indicate that audio data source is raw audio retrieved and loaded from a URL. Audio Segment with “text URL” type indicate that audio data source is raw audio generated by a Speech Synthesizer for text retrieved from a URL. Audio Segment with “text string” type indicate that audio data source is raw audio generated by a Speech Synthesizer for the text string included in the Audio Segment configuration. According to various embodiments, and with reference to FIG. 14B, loading an Audio Segment 564 in VFF 110 includes checking type of Audio Segment 5644, and if type is “audio URL” then the audio URL is checked if valid or not 5645. If audio URL is not valid, then Load Audio Segment 564 retrieves a text string mapped to the audio URL 5647 from Audio-to-Text Map List 40 retrieved through 5649 and replaces Audio Segment type with “text string” at 5647. Load Audio Segment 564 then completes loading Audio Segment playback parameters 5646.

With reference to FIG. 14A and according to various embodiments, during PlayAudio VFM processing, VFF 110 loads a single selected Audio Segment 564 referenced in the selected APM 556 and requests Media Controller 212 in MF 210 to execute “Play Audio Segment” 570 resulting with audio playback of Audio Segment to User on Device. MF 210 processes the Audio Segment for audio playback. During processing of Audio Segment, Media Event Observer 116 in VFF 110 receives 215 a plurality of “Play Audio” events from Media Event Notifier 214 in MF 210. VFF 110 evaluates the media events received 574 associated with the “Play Audio” function. If media event value is “Stopped”, which refers to audio playback of Audio Segment stopping before completion, then VFF 110 ignores the remaining APMs and Audio Segments to be processed for audio playback, and completes and ends its PlayAudio VFM processing 584. If media event value is “Ended”, which refers to completion of audio playback of Audio Segment, then VFF 110 checks if next Audio Segment is available for audio playback 576. if available, VFF 110 selects next Audio Segment for audio playback 578, loads the Audio Segment 564, and requests MF 210 to execute “Play Audio Segment” 570. If next Audio Segment is not available at 576, then VFF 110 checks if next APM is available for processing 580. If available, VFF 110 selects next APM for processing 582 and proceeds with constructing and loading the next APM 556. If next APM is not available for processing at 580, then VFF 110 completes and ends its PlayAudio VFM processing 584.

The following table 3 shows JSON examples of PlayAudio VFMs for processing. Table 4 following table 3 shows JSON examples of APMs referenced in PlayAudio VFMs from table 3 and examples of other APMs referenced from APMs in table 4.

TABLE 3

| | | |
|---|---|---|
| 1 | { | |
| 2 | ″id″: ″1010_PlayAudio_Hello″, | ← ID of VFM - Passed to client |
| | | during Callbacks. |
| 3 | ″type″: ″playAudio″, | ← Type of VFM: “playAudio”. |
| 4 | ″name″: ″Speak Greeting″, | ← Descriptive VFM name. |
| 5 | ″playAudioParams″: { | ← Specifies APM parameters. |
| 6 | ″style″: ″single″, | ← Specifies APM type: “single” |
| 7 | ″APM-ID″: ″P_Hello″, | ← Specifies APM ID to process for |
| | | audio playback. |
| 8 | }, | |
| 9 | ″goTo″: { | ← Specifies VFMs to transition to |
| | | after VFM resumes and completes |
| | | processing. |
| 10 | ″DEFAULT″: ″1020_PlayAudio_Intro″, | ← Specifies default VFM ID to |
| | | transition to. VFM with this ID is |
| | | shown next. |
| 11 | }, | |
| 12 | }, | |
| 13 | { | |
| 14 | ″id″: ″1020_PlayAudio_Intro″, | ← ID of VFM - Passed to client |
| | | during Callbacks. |
| 15 | ″type″: ″playAudio″, | ← Type of VFM: “playAudio”. |
| 16 | ″name″: ″Speak Introduction″, | ← Descriptive VFM name. |
| 17 | ″playAudioParams″: { | ← Specifies APM parameters. |
| 18 | ″style″: ″combo″, | ← Specifies APM type: “combo” |
| 19 | ″APMGroup″: [ | ← Specifies an APM Group since |
| | | APM Style is “combo”. |
| 20 | { | |
| 21 | ″APMID″: ″P_RecordedAudioIntro1″, | ← Specifies APM ID of first APM in |
| | | APM Group. |
| 22 | }, | |
| 23 | { | |
| 24 | ″APMID″: ″P_SSAudioIntro2″, | ← Specifies APM ID of second |
| | | APM in APM Group. |
| 25 | }, | |
| 26 | { | |
| 27 | ″ APMID ″: ″P_DynamicAudioIntro3″, | ← Specifies APM ID of third APM |
| | | in APM Group. |
| 28 | }, | |
| 29 | { | |
| 30 | ″ APMID ″: ″P_ReferenceOtherAPM″, | |
| | | ← Specifies APM ID of fourth APM |
| 31 | }, | in APM Group. |
| 32 | ], | |
| 33 | }, | |
| 34 | ″goTo″: { | |
| | | ← Specifies VFMs to transition to |
| 35 | ″DEFAULT″: ″1030_OtherVFM″, | after VFM completes processing. |
| | | ← Specifies default VFM ID to |
| 36 | }, | transition to. |
| 37 | }, | |

TABLE 4

| | | |
|---|---|---|
| 1 | { | |
| 2 | ″id″: ″P_Hello″, | ← ID of APM - Passed to client during |
| | | Callbacks. Referenced from |
| | | ″1010_PlayAudio_Hello″ VFM in Table 3 |
| 3 | ″style″: ″single″, | ← Style of APM: “single”. |
| 4 | ″audioFile″: ″Hello.wav″, | ← Audio File URL for audio playback. |
| 5 | }, | |
| 6 | { | |
| 7 | ″id″: ″P_RecordedAudioIntro1″, | ← ID of APM - Passed to client during |
| | | Callbacks. Referenced from |
| | | ″1020_PlayAudio_Intro ″ VFM in Table 3 |
| 8 | ″style″: ″single″, | ← Style of APM: “single”. |
| 9 | ″audioFile″: ″Intro1.wav″, | ← Audio File URL for audio playback. |
| 10 | }, | |
| 11 | { | |
| 12 | ″id″: ″P_SSAudioIntro2″, | ← ID of APM - Passed to client during |
| | | Callbacks. Referenced from |
| | | ″1020_PlayAudio_Intro ″ VFM in Table 3 |
| 13 | ″style″: ″single″, | ← Style of APM: “single”. |
| 14 | ″textString″: ″This is text for intro 2.” | ← Text String sent to Speech Synthesizer |
| | | for audio playback. |
| 15 | “SSEngine”: “apple” | |
| | | ← specifies the “apple” Speech |
| 16 | }, | Synthesizer engine to use. |
| 17 | { | |
| 18 | ″id″: ″P_DynamicAudioIntro3″, | |
| | | ← ID of APM - Passed to client during |
| | | Callbacks. Referenced from |
| 19 | ″style″: ″single″, | ″1020_PlayAudio_Intro ″ VFM in Table 3 |
| 20 | ″audioFile″: ″$[Intro3URL]″, | ← Style of APM: “single”. |
| | | ← Audio File URL is dynamic and is set at |
| | | runtime by client. Client assigns the Audio |
| 21 | }, | File URL as a value to the key “Intro3URL”. |
| 22 | { | |
| 23 | ″id″: ″P_ReferenceOtherAPM″, | |
| | | ← ID of APM - Passed to client during |
| | | Callbacks. Referenced from |
| 24 | ″style″: ″select″, | ″1020_PlayAudio_Intro ″ VFM in Table 3 |
| 25 | ″ APMGroup″: [ | ← Style of APM: “select”. |
| 26 | { | ← APM references other APMs. |
| 27 | ″ APMID ″: ″P_Sure″, | |
| | | ← Specifies APM ID to process for audio |
| 28 | }, | playback if selected. |
| 29 | { | |
| 30 | ″ APMID ″: ″P_Ok″, | |
| | | ← Specifies APM ID to process for audio |
| 31 | }, | playback if selected. |
| 32 | { | |
| 33 | ″ APMID ″: ″P_LetsChat″, | |
| | | ← Specifies APM ID to process for audio |
| 34 | }, | playback if selected. |
| 35 | ], | |
| 36 | }, | |
| 37 | { | |
| 38 | ″id″: ″P_Sure″, | |
| | | ← ID of APM - Passed to client during |
| | | Callbacks. Referenced from |
| 39 | ″style″: ″single″, | ″P_ReferenceOtherAPM ″ APM. |
| 40 | ″audioFile″: ″Sure.wav″, | ← Style of APM: “single”. |
| 41 | }, | ← Audio File URL for audio playback. |
| 42 | { | |
| 43 | ″id″: ″P_Ok″, | |
| | | ← ID of APM - Passed to client during |
| | | Callbacks. Referenced from |
| 44 | ″style″: ″single″, | ″P_ReferenceOtherAPM ″ APM. |
| 45 | ″textString″: ″Ok.″, | ← Style of APM: “single”. |
| | | ← Text String sent to Speech Synthesizer |
| 46 | }, | for audio playback. |
| 47 | { | |
| 48 | ″id″: ″P_LetsChat″, | |
| | | ← ID of APM - Passed to client during |
| | | Callbacks. Referenced from |
| 49 | ″style″: ″single″, | ″P_ReferenceOtherAPM ″ APM. |
| 50 | ″textFile″: ″letsChat.txt″, | ← Style of APM: “single”. |
| | | ← Text File URL containing text to send to |
| 51 | }, | Speech Synthesizer for audio playback. |

### 9. Processing RecordAudio VFM

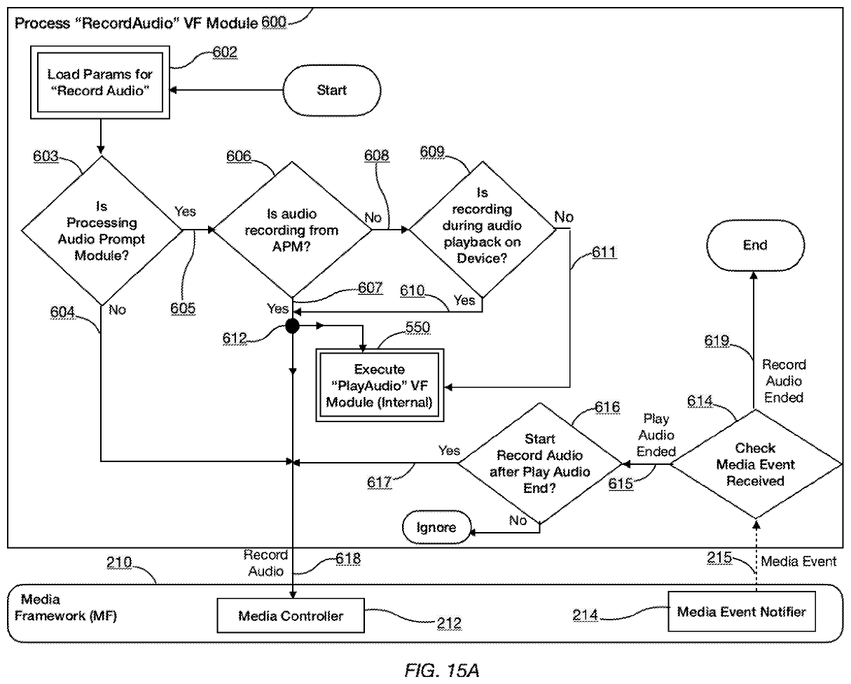

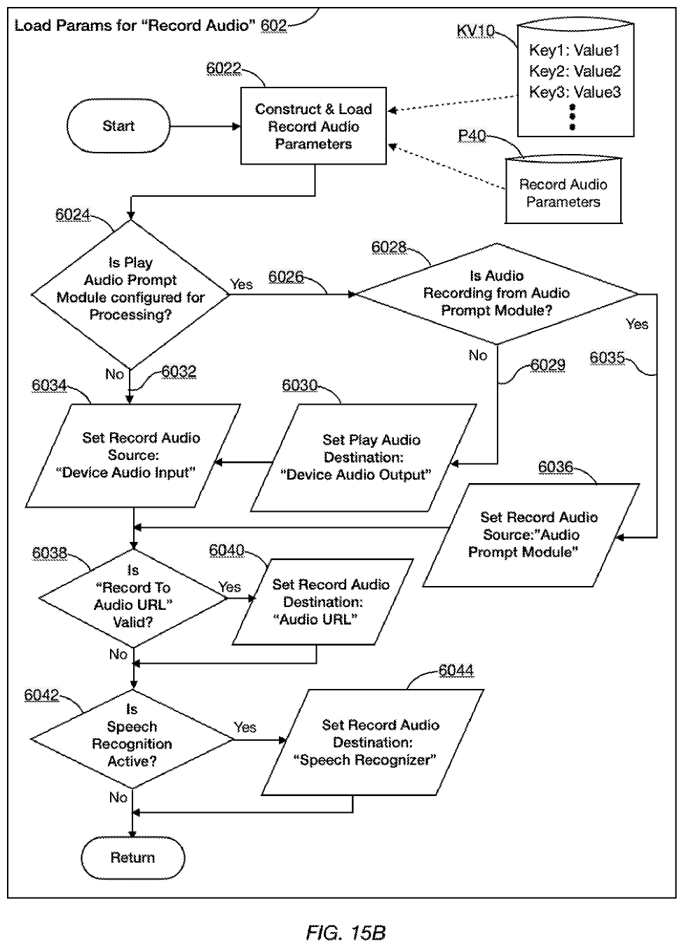

FIG. 15A and FIG. 15B illustrate block diagrams of VFF 110 processing a RecordAudio VFM 600 as configured in a VoiceFlow, which when processed, results in audio recorded from one of a plurality of audio data sources to a plurality of audio data destinations, according to various embodiments. According to various examples and embodiments, a RecordAudio VFM is configured with media parameters for Record Audio 602 that VFF 110 passes to MF 210 to specify to MF 210 the audio data source and destination to be used for audio recording. According to various examples and embodiments, audio data source can be, but not limited to, Device internal or external microphone, Device Bluetooth audio input, a speech synthesizer, an audio URL or Audio Segments referenced in an APM. According to various examples and embodiments, audio data recording destination can be, but not limited to, a destination audio file, URL or a speech recognizer.

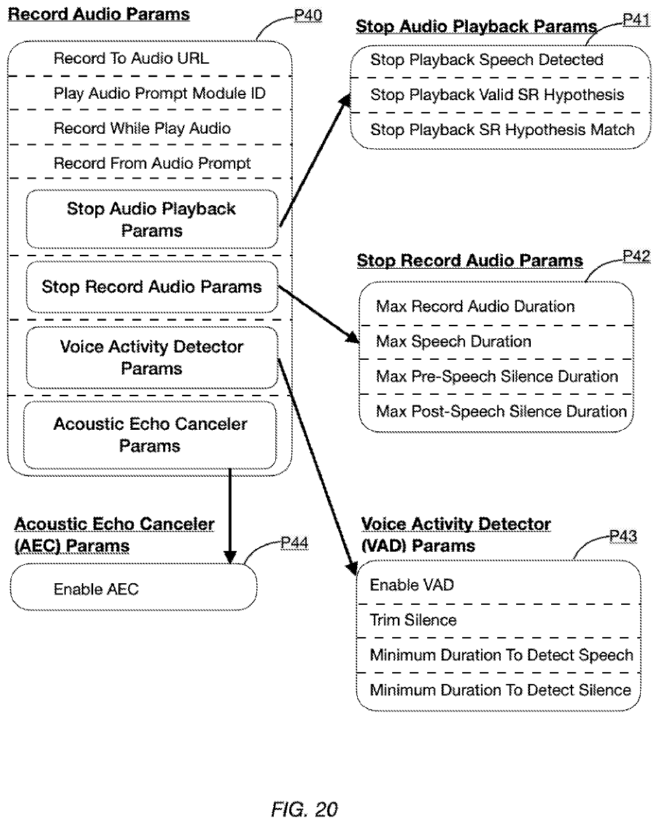

With reference to FIG. 15B and according to various embodiments, Record Audio parameters are constructed and loaded 6022 from configured Record Audio parameters P40 (illustrated in FIG. 20) configured in RecordAudio VFM and from dynamic runtime parameters KV10.

According to various examples and embodiments, the parameter “Play Audio Prompt Module ID” shown in P40 when configured for Record Audio parameters P40 in RecordAudio VFM, provides the option to enable processing an APM for audio playback to a Device internal or external speaker, to Device headphones or to Device Bluetooth speaker, prior or during the function of recording audio to an audio destination. According to various examples, acoustic echo is captured in the recording audio destination when audio playback is configured to execute during the function of recording audio on Devices that do not support on-Device AEC.

According to various examples and embodiments, the parameter “Record Audio Prompt” parameter, specified in Record Audio parameters P40 and configured in RecordAudio VFM, provides the option to enable audio recording from an APM, also identified by the parameter “Play Audio Prompt Module ID” shown in P40, directly to an audio destination. With that, the source of audio data recorded is the raw audio data content of the Audio Segments composing the APM referenced by the “Play Audio Prompt Module ID” parameter shown in P40. In this scenario, the APM is no longer processed for audio playback.

According to various examples, Voice Activity Detector parameters P43 (illustrated in FIG. 20) included in P40 and configured in RecordAudio VFM contain the “Enable VAD” option to enable a Voice Activity Detector 238 in MF 210 to process recorded audio and provide voice activity statistics that support many audio recording activities comprising: generating voice activity data and events; recording raw audio data with speech energy only; and/or signaling end of speech energy for audio recording to stop.

According to various examples, Acoustic Echo Canceler parameters P44 (illustrated in FIG. 20) included in P40 and configured in RecordAudio VFM contain the “Enable AEC” option to enable an Acoustic Echo Canceler 240 in MF 210 to process recorded audio while audio playback is active, and provide Acoustic Echo Canceling on Devices that do not support software-based or hardware-based on-Device AEC. With AEC enabled, recorded audio will contain canceled echo of audio playback in recorded audio.

According to various examples, Stop Audio Playback parameters P41 (illustrated in FIG. 20) included in P40 and configured in RecordAudio VFM contain the parameter “Stop Playback Speech Detected” which, when enabled, results with MF 210 automatically stopping active audio playback during audio recording when speech energy from User is detected by VAD and controlled by “Minimum Duration To Detect Speech” parameter in P43.

According to various examples, Stop Record Audio parameters P42 (illustrated in FIG. 20) included in P40 and configured in RecordAudio VFM contain parameters that control when to automatically stop and end audio recording while processing of RecordAudio VFM. These parameters comprise: maximum record audio duration; maximum speech duration; max pre-speech silence duration; and max post-speech silence duration.

With reference to FIG. 15B and according to various embodiments, RecordAudio VFM processing determines if a Play APM is configured for processing 6024, and if so 6026, whether data source for audio recording is the audio contained in Audio Segments referenced by the APM 6028. If not 6029, audio from APM processing will be sent for audio playback on Device and the audio playback destination is set to “Device Audio Output” 6030 which includes, but not limited to, Device internal or external headphones or Bluetooth speakers. Otherwise, if the data source for audio recording is the audio contained in Audio Segments referenced by the APM 6035, audio from APM processing will be recorded directly to a destination and the recording audio data source is set to “Audio Prompt Module” 6036. If no APM is configured for processing 6032, then the audio data source is set to “Device Audio Input” 6034 by default which includes, but not limited to, Device internal or external microphones or Bluetooth microphones. If URL to record audio data to 6038 is configured and is valid, then one recording audio destination is set to “Audio URL” 6040. If speech recognition is active on the recorded audio data 6042, then another recording audio destination is set to “Speech Recognizer” 6044, which may be the case when Record Audio Parameters P40 are embedded in an AudioDialog VFM or an AudioListener VFM as will be presented later.

With reference to FIG. 15A and according to various embodiments, RecordAudio VFM processing checks if an APM will be processed 603. If not 604, VFF 110 requests Media Controller 212 in MF 210 to “Record Audio” 618 from a Device audio input, for example, but not limited to, active Device microphone.

With Reference to FIG. 15A and according to various embodiments, if an APM will be processed 605, audio recording from APM to a destination is checked 606. If APM is the source of recorded audio data 607, then according to various embodiments, VFF 110 processes sequentially and asynchronously 612 two tasks: VFF 110 requests Media Controller 212 in MF 210 to “Record Audio” 618 from APM as the audio data source to be recorded; and it executes an internally created “PlayAudio” VFM 550 to provide the audio data source from APM processing for recording raw audio instead for audio playback.

With Reference to FIG. 15A and according to various embodiments, if APM is processed for audio playback 608 on Device audio output, such as but not limited to, active Device speaker, then, VFF 110 checks if recording raw audio will occur during audio playback 609 on Device, and if so 610, and according to various embodiments, VFF 110 processes sequentially and asynchronously 612 two tasks: VFF 110 requests Media Controller 212 in MF 210 to “Record Audio” 618 from a Device audio input such as, but not limited to, active Device microphone; and it executes an internally created “PlayAudio” VFM 550 to process audio playback of APM on Device audio output such as, but not limited to, active Device speaker.

With Reference to FIG. 15A and according to various embodiments, if recording audio data starts after processing APM for audio playback on Device completes 611, VFF 110 executes an internally created “PlayAudio” VFM 550 to process APM for audio playback on Device audio output such as, but not limited to, active Device speaker. For this embodiment, VFF 110 checks media events 614 it receives 215 from Media Event Notifier 214 in MF 210. When VFF 110 receives “Play Audio Ended” media event 615, VFF 110 checks to start recording audio after Play Audio ended 616, and if so 617, VFF 110 requests MF 210 to “Record Audio” 618 from Device audio input, for example, but not limited to, active Device microphone.

With Reference to FIG. 15A and according to various embodiments, processing of RecordAudio VFM completes and ends when VFF 110 receives a “Record Audio Ended” media event 619 from MF 210. Stop Audio Record Parameters P44 (illustrated in FIG. 20) included in P40 and configured in RecordAudio VFM provides conditions and controls for MF 210 to automatically stop audio recording. VFF 110 and other MF 210 clients can also request Media Controller 212 in MF 210 to stop audio recording by calling its API.

The following table 5 shows a JSON example of RecordAudio VFM for processing.

TABLE 5

| | | |
|---|---|---|
| 1 | { | |
| 2 | ″id″: ″5010_RecordSampleAudio″, | ← ID of VFM - Passed to client |
| | | during Callbacks. |
| 3 | ″type″: ″recordAudio″, | ← Type of VFM: “recordAudio”. |
| 4 | ″name″: ″Recording Sample Audio″, | ← Descriptive VFM name. |
| 5 | ″recordAudioParams″: { | ← Specifies Record Audio |
| | | parameters. |
| 6 | ″recordToAudioURL″: | ← URL for storing recorded audio. |
| | ″/Tmp/RecordedAudio/ SampleAudio.wav ″, | ← Specifies APM ID to process for |
| 7 | ″playAudioAPMID″: | audio playback or for it to be the |
| | ″P_LeaveMessageAfterBeep″, | audio source to be recorded. |
| | | ← Record audio during audio |
| 8 | ″recordWhilePlayAudio″: true, | playback. |
| | | ← Not recording audio from APM. |
| 9 | ″recordFromAudioPrompt″: false, | APM will be processed for audio |
| | | playback. |
| | | ← VAD Parameters. |
| 10 | ″vadParams″: { | ← VAD is enabled. |
| 11 | ″enableVAD″: true, | ← Do not trim silence in recorded |
| 12 | ″trimSilence″: false, | audio. |
| | | ← Specifies 200 milliseconds |
| 13 | ″minDurationToDetectSpeech″: 200, | minimum duration of detected |
| | | speech energy to transition to |
| | | speech energy mode. |
| | | ← Specifies 500 milliseconds |
| 14 | ″minDurationToDetectSilence″: 500, | minimum duration of detected |
| | | silence to transition to silence |
| | | mode. |
| 15 | } | ← AEC Parameters. |
| 16 | ″aecParams″: { | ← AEC is disabled. Assumes that |
| 17 | ″enableAEC″: false, | Device has on-Device AEC. |
| 18 | } | |
| | | ← Specifies parameters for |
| 19 | ″stopAudioPlaybackParams″: { | stopping audio playback during |
| | | audio recording. |
| | | ← Stop audio playback when |
| 20 | ″stopPlaybackSpeechDetected″: true, | speech is detected from User. |
| 21 | }, | ← Specifies parameters for audio |
| 22 | ″stopRecordAudioParams″: { | recording to stop. |
| | | ← Stop audio recording when audio |
| 23 | ″max RecordAudioDuration″: 10000, | recording duration exceeds 10,000 |
| | | milliseconds. |
| | | ← Stop audio recording when |
| 24 | ″maxPostSpeechSilenceDuration″: | silence duration after detected |
| | 4000, | speech exceeds 4000 milliseconds. |
| 25 | }, | |
| 26 | }, | |
| | | ← Specifies VFMs to transition to |
| 27 | ″goTo″: { | after VFM resumes and completes |
| | | processing. |
| | | ← Specifies default VFM ID to |
| 28 | ″DEFAULT″: ″VF_END″, | transition to. “VF_END” VFM ends |
| | | processing of VoiceFlow. |
| 29 | }, | |
| 30 | }, | |

### 10. Processing AudioDialog VFM

FIG. 16 illustrates block diagrams of VFF 110 processing an AudioDialog VFM 650 as configured in a VoiceFlow, which when processed, results in a speech-enabled conversational interaction between Program and User according to various embodiments.

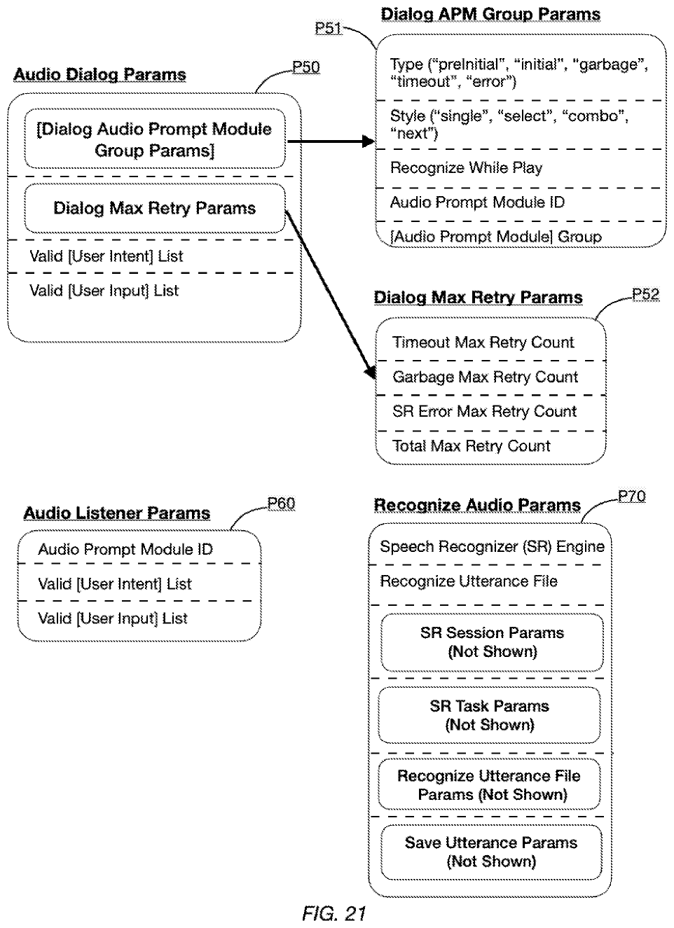

With Reference to FIG. 16 and according to various examples and embodiments, AudioDialog VFM processing starts by first constructing and loading the speech recognition media parameters 652 and the AudioDialog parameters 654, which define the speech-enabled conversational interaction experience with User, from multiple configuration sources accessed through 653 comprising: Audio Dialog Parameters P50 & P51 configured in AudioDialog VFM (P50 & P51 illustrated in FIG. 21); Recognize Audio Parameters P70 configured in AudioDialog VFM (P70 illustrated in FIG. 21); Record Audio Parameters P40 configured in AudioDialog VFM (P40 illustrated in FIG. 20); and dynamic runtime parameters KV10 (KV10 illustrated in FIG. 8).

With Reference to FIG. 16 and according to various examples and embodiments, VFF 110 checks if the AudioDialog VFM is configured to simply execute an offline speech recognition task performed on a recorded utterance 656, and if so, VFF 110 executes “Recognize Recorded Utterance” task 657 and proceeds to end the VFM processing 684. According to various examples and embodiments, VFF 110 checks 656 if the AudioDialog VFM is configured to execute a speech-enabled interaction 657 between Program and User starting with the queueing of audio playback for APM group of type “Initial” 658 to start the interactive dialog with User. According to various examples and embodiments, for best User experience and/or to present a specific interaction experience with User, User may be allowed to provide speech input during audio playback to User and for User to effectively Barge-In and stop audio playback. User can provide speech input at any time during PlayAudio VFM processing 550 and after PlayAudio VFM processing 550 ends. If User provides speech input during PlayAudio VFM processing 550, then VAD events, and partial or complete SR Hypotheses are evaluated in real time, as configured and controlled by: Audio Dialog parameters P50 and P51; Recognize Audio parameters P70; and Record Audio parameters P40. Before starting the interactive dialog with User, VFF 110 first checks if Barge-In is enabled or not 664 for User, controlled by, according to various examples, “Recognize While Play” parameter referenced in P51.

With Reference to FIG. 16 and according to various examples and embodiments, If Barge-In is not active 666, VFF 110 proceeds with starting audio playback by processing an internally created PlayAudio VFM that references the APM group 550 (illustrated in FIG. 14A) which VFF 110 last set up. When audio playback is completed, Media Event Notifier 214 from MF 210 notifies VFF 110 with the media event “Play Audio Ended” 670. VFF 110 checks Barge-In is not active 672, and if so 674, VFF 110 requests Media Controller 212 in MF 210 to start “Recognize Audio” 675.

With Reference to FIG. 16 and according to various examples and embodiments, If Barge-In is active 667, VFF 110 requests Media Controller 212 in MF 210 to start “Recognize Audio” 675. MF 210 starts speech recognition and its Media Event Notifier 214 notifies 215 VFF 110 with the media event “Recognize Audio Started” 676. 678 checks if Barge-In is active, and if so, proceeds with starting audio playback by processing an internally created PlayAudio VFM that references the APM group 550 (illustrated in FIG. 14A) which VFF 110 last set up.

With Reference to FIG. 16 and according to various examples and embodiments, VFF 110 checks other media events received 668 from MF 210 through 215. If an “SR Hypothesis” media event is received 669, VFF 110 processes SR Hypothesis 950 (illustrated in FIG. 18). VFF 110 checks the SR Hypothesis processing result 680 and performs the following comprising: if valid SR Hypothesis, or maximum retries is reached or an error is encountered, VFF 110 ends its VFM processing 684; if “Garbage” 681, VFF 110 queues audio APM group of type “Garbage” 660 for initial or reentry audio playback; or if “Timeout” 682, VFF 110 queues audio APM group of type “Timeout” 662 for initial or reentry audio playback. VFF 110 then proceeds to evaluate Barge-In state 664 as aforementioned and continues VFM processing.

With reference to FIG. 16 and according to various embodiments of the current invention, during AudioDialog VFM processing, VFF 110 creates dynamically, internally and at different instances, multiple configurations of PlayAudio VFM to process 550 as part of AudioDialog VFM processing in order to address and handle the various audio playbacks to User throughout the lifecycle of the AudioDialog VFM processing.

With Reference to FIG. 18 and according to various examples and embodiments, For AudioDialog VFM processing, an AudioDialog VFM specifies rules for processing events 950 received from MF 210 during the execution of speech recognition tasks. VFF 110 evaluates events 952 received from MF 210 comprising: if an error event 953, an “Error” is returned 954 from 950 to Process “AudioDialog” VF Module 650, checked at 680 and results with end of AudioDialog VFM processing 684; or if a garbage/timeout event 955, VFF 110 checks first whether VFM being processed is of type AudioDialog or AudioListener 956. If of type AudioDialog, VFF 110 increments timeout or garbage counters, and total retry counters 958, checks for a maximum retry count reached 959, and if a maximum retry count is reached 960, a “Max Retries” is returned 962 from 950 to Process “AudioDialog” VF Module 650, checked at 680 and results with end of AudioDialog VFM processing 684, but if maximum retry count is not reached 961, a “Garbage” or “Timeout” is returned 964 from 950 to Process “AudioDialog” VF Module 650, checked at 680 and results with continuation of AudioDialog VFM processing at 660 or 662.

With Reference to FIG. 18 and according to various examples and embodiments, For AudioDialog VFM processing, an AudioDialog VFM specifies rules for processing SR Hypotheses received from SR Engine executing in MF 210. VFF 110 evaluates events 952 from SR Engine further comprising: if partial or complete SR hypothesis event 972, then VFF 110 compares SR Hypothesis 974 to a list of configured partial and complete text utterances “Valid [User Input] List” (P50 illustrated in FIG. 21) accessed through 973. According to various examples and embodiments, comparing SR Hypothesis 974 to the list of configured partial and complete text utterances comprise: determining if SR Hypothesis is an exact match to a configured User input; if SR Hypothesis starts with a configured User input; or if SR Hypothesis contains a configured User input. If a match is found 975, then “Valid” is returned 994 from 950 to Process “AudioDialog” VF Module 650 which results with end of AudioDialog VFM processing 684. If no match is found, VFF 110 makes a Callback 114 with “Recognize Audio” function (360 in FIG. 7) at 977 to VFC 16 with “SR Hypothesis Partial” or “SR Hypothesis Final” media events (listed in 370 illustrated in FIG. 7). With reference to various examples, during the Callback, VFC 16 processes and either classifies the SR Hypothesis 980 to a valid User intent 982 and sets the classified User Intent 983 in UI10 (illustrated in FIG. 8) using a request to VFF 110 API, or rejects it as an invalid or incomplete SR hypothesis by resetting the SR Hypothesis to “Garbage” 984, or does not make a decision 985. After Callback returns 987 from VFC 16, VFF 110 checks 988 VFC 16 SR hypothesis disposition obtained from UI10 against valid intents configured in Audio Dialog Parameters P50 with 986 representing VFF 110 access to Ul10 and P50: if rejected and set to “Garbage” 989, VFF 110 continues VFM processing at 956, as aforementioned in previous paragraph; if “No Decision”, “No Decision” is returned 990 from 950 to Process “AudioDialog” VF Module 650, checked and ignored at 680 and results with continued and uninterrupted AudioDialog VFM processing; or, if “Valid Input or Intent” 992, “Valid” is returned 994 from 950 to Process “AudioDialog” VF Module 650 which results with end of AudioDialog VFM processing 684.

The following table 6 shows a JSON example of AudioDialog VFM for processing.

TABLE 6

| | | |
|---|---|---|
| 1 | { | |
| 2 | ″id″: ″1020_GetInput″, | ← ID of VFM - Passed to client during |
| | | Callbacks. |
| 3 | ″type″: ″audioDialog″, | ← Type of VFM: “audioDialog”. |
| 4 | ″name″: ″GetResponse″, | ← Descriptive VFM name. |
| 5 | ″recognizeAudioParams″: { | ← Specifies Recognize Audio |
| | | parameters. |
| 6 | ″srEngine″: ″apple″, | ← Specifies SR Engine. |
| 7 | ″langLocaleFolder″: ″en-US″, | ← Specifies Language Locale: US |
| | | English. |
| 8 | | ← Specifies SR Engine session |
| | ″SRSession Params″: { | parameters |
| 9 | | ← Enable partial results is disabled |
| 10 | ″enablePartialResults″: false, | |
| 11 | }, | |
| 12 | }, | ← Specifies Audio Dialog parameters. |
| 13 | ″audio Dialog Params″: { | ← Specifies the dialog maximum retry |
| | ″dialogMaxRetryParams″: { | counts. |
| 14 | | ← Maximum timeout count is 3. |
| 15 | ″timeoutMaxRetryCount″: 3, | ← Maximum garbage count is 3. |
| 16 | ″garbageMaxRetryCount″: 3, | ← Maximum SR error count is 1. |
| 17 | ″srErrorMaxRetryCount″: 2, | ← Total maximum retry count is 3. |
| 18 | ″totalMaxRetryCount″: 3, | |
| 19 | }, | ← Specifies the dialog APM Groups. |
| 20 | ″dialogPromptCollection″: [ | ← First APM Group. |
| 21 | { | ← APM Group type is “initial”. |
| 22 | ″type″: ″initial″, | ← APM Group style is “select”. |
| 23 | ″style″: ″select″, | ← Recognize during audio playback is |
| | ″recognizeWhilePlay″: true, | enabled allowing User to Barge-In. |
| 24 | | ← Specifies APMs in the “initial” APM |
| | ″APMGroup″: [ | Group. |
| 25 | | |
| 26 | { | ← First APM ID |
| 27 | ″APMID″: ″P_WhatCanDoForYou″, | |
| 28 | }, | |
| 29 | { | ← Second APM ID |
| 30 | ″APMID″: ″P_WhatCanIHelpWith″, | |
| 31 | }, | |
| 32 | { | ← Third APM ID |
| 33 | ″APMID″: ″P_HowCanIHelpYou″, | |
| 34 | }, | |
| 35 | ], | |
| 36 | }, | |
| 37 | { | ← APM Group type is “garbage”. |
| 38 | ″type″: ″garbage″, | ← APM Group style is “serial”. |
| 39 | ″style″: ″serial″, | ← Recognize during audio playback is |
| | ″recognizeWhilePlay″: true, | enabled allowing User to Barge-In. |
| 40 | | ← Specifies APMs in the “garbage” APM |
| | ″APMGroup″: [ | Group. |
| 41 | | |
| 42 | { | ← First APM ID |
| 43 | ″ APMID ″: ″P_ Garbage1_Combo″, | |
| 44 | }, | |
| 45 | { | ← Second APM ID |
| 46 | ″ APMID ″: ″P_Garbage2_Combo″, | |
| 47 | }, | |
| 48 | { | ← Third APM ID |
| 49 | ″ APMID ″: ″P_Garbage3_Combo″, | |
| 50 | }, | |
| 51 | ], | |
| 52 | }, | |
| 53 | { | ← APM Group type is “timeout”. |
| 54 | ″type″: ″timeout″, | ← APM Group style is “serial”. |
| 55 | ″style″: ″serial″, | ← Recognize during audio playback is |
| | ″recognizeWhilePlay″: true, | enabled allowing User to Barge-In. |
| 56 | | ← Specifies APMs in the “timeout” APM |
| | ″APMGroup″: [ | Group. |
| 57 | | |
| 58 | { | ← First APM ID |
| 59 | ″ APMID ″: ″P_ Timeout1_Combo″, | |
| 60 | }, | |
| 61 | { | ← Second APM ID |
| 62 | ″ APMID ″: ″P_ Timeout2_Combo″, | |
| 63 | }, | |
| 64 | { | ← Third APM ID |
| 65 | ″ APMID ″: ″P_ Timeout3_Combo″, | |
| 66 | }, | |
| 67 | ], | |
| 68 | }, | |
| 69 | { | ← APM Group type is “sr_error”. |
| 70 | ″type″: ″sr_error″, | ← APM Group style is “single”. |
| 71 | ″style″: ″single″, | ← Recognize during audio playback is |
| 72 | ″recognizeWhilePlay″: false, | disabled preventing User from Barge-In. |
| 73 | ″playInitialAfter″: false, | ← Specifies APMs in the “sr_error” APM |
| | ″APMGroup″: [ | Group. |
| 74 | | |
| 75 | { | ← First APM ID |
| 76 | ″ APMID ″: ″P_ SR_Error1 ″, | |
| 77 | }, | |
| 78 | ], | |
| 79 | }, | |
| 80 | ], | |
| 81 | }, | ← Specifies Record Audio parameters. |
| 82 | ″recordAudioParams″: { | ← Specifies parameters for stopping |
| | ″stopAudioPlaybackParams″: { | audio playback during speech recognition. |
| 83 | | ← Stop audio playback when speech is |
| | ″stopPlaybackSpeechDetected″: false, | detected is disabled. |
| 84 | | ← Stop audio playback when valid SR |
| | ″stopPlaybackValidSRHypothesis″: true, | Hypothesis is enabled. |
| 85 | | |
| 86 | }, | ← Specifies VAD Parameters. |
| 87 | ″vadParams″: { | ← VAD is enabled. |
| 88 | ″enableVAD″: true, | |
| | ″trimSilence″: true, | ← Trim silence in audio before sending to |
| 89 | | Speech Recognizer |
| | ″minDurationToDetectSpeech″: 200, | ← Specifies 200 milliseconds minimum |
| | | duration of detected speech energy to |
| 90 | | transition to speech energy mode. |
| | ″minDurationToDetectSilence″: 500, | ← Specifies 500 milliseconds minimum |
| | | duration of detected silence to transition |
| 91 | | to silence mode. |
| 92 | }, | |
| 93 | ″aecParams″: { | ← Specifies AEC Parameters. |
| 94 | ″enableAEC″: true, | ← AEC is enabled on recorded audio. |
| 95 | }, | |
| | ″stopRecordParams″: { | ← Specifies parameters for audio |
| 96 | | recording to stop. |
| | ″maxPreSpeechSilenceDuration″: 3000, | ← Stop audio recording and speech |
| | | recognition when silence duration |
| | | exceeds 3 seconds before speech is |
| 97 | | detected from User. |
| | | ← Stop audio recording and speech |
| | ″maxPostSpeechSilenceDuration″: | recognition when silence duration |
| | 2000, | exceeds 2 seconds after speech is no |
| 98 | | longer detected from User. |
| 99 | | |
| 100 | }, | |
| | }, | ← Specifies VFMs to transition to after |
| 101 | ″goTo″: { | VFM resumes and completes processing. |
| | | ← Transition to VFM ID “9010” when |
| 102 | ″maxTimeoutCount″: ″9010″, | maximum timeout count is reached. |
| | | ← Transition to VFM ID “9020” when |
| 103 | ″maxGarbageCount″: ″9020″, | maximum garbage count is reached. |
| | | ← Transition to VFM ID “9030” when |
| 104 | ″maxTotalRetryCount″: ″9030″, | maximum total retry count is reached. |
| | | ← Transition to VFM ID “9040” when |
| 105 | ″maxSRErrorCount″: ″9040″, | maximum SR error count is reached. |
| | | ← Transition to VFM ID “9050” an APM |
| 106 | ″loadPromptFailure″: ″9050″, | load fails. |
| 107 | ″internalFailure″: ″9060″, | ← Transition to VFM ID “9060” for any |
| | | internal framework failures. |
| 108 | ″DEFAULT″: ″1020PlaySR″, | ← Default Transition to VFM ID |
| | | “1020PlaySR”. |
| 109 | ″userInputCollection″: [ | ← Specifies VFMs to transition to if User |
| 110 | | Input matches one from User input list. |
| 111 | { | |
| 112 | ″comparator″: ″contains″, | ← Comparator: “contains”. |
| 113 | ″input″: ″yes″, | ← Transition to VFM ID “1030” if User |
| 114 | ″goTo″: ″1030″, | input contains “yes”. |
| | }, | |
| 115 | { | |
| 116 | ″input″: ″no″, | ← Comparator default: “equals”. |
| 117 | ″goTo″: ″1040″, | ← Transition to VFM ID “1040” if User |
| 118 | }, | input matches “no”. |
| 119 | { | |
| 120 | ″comparator″: ″starts″, | ← ″comparator″: ″ starts ″, |
| 121 | ″input″: ″go to sleep″, | ← Transition to VFM ID “1050” if User |
| 122 | ″goTo″: ″1050″, | input starts with “go to sleep”. |
| | }, | |
| 123 | ], | |
| 124 | | |
| | ″userIntentCollection″: [ | ← Specifies VFMs to transition to if User |
| 125 | | Input is classified to a User Intent that |
| 126 | | matches one from User intent list. |
| 127 | { | |
| 128 | ″intent″: ″GoBackward″, | ← Transition to VFM ID “G_GoBackward” |
| 129 | ″goTo″: ″G_GoBackward″, | if User intent matches “GoBackward”. |
| 130 | }, | |
| 131 | { | |
| 132 | ″intent″: ″GoForward″, | ← Transition to VFM ID “G_GoForward” if |
| 133 | ″goTo″: ″G_GoForward″, | User intent matches “GoForward”. |
| 134 | }, | |
| 135 | ], | |
| | }, | |
| | }, | |

### 11. Processing AudioListener VFM

FIG. 17 illustrates block diagrams of VFF 110 processing an AudioListener VFM 700 as configured in a VoiceFlow, which when processed and according to various embodiments, results in presenting User with a continuous audio recitation, reading or narration of one or a plurality of recorded audio files or audio URLs, or raw audio streams generated by Speech Synthesizers, or a combination thereof, played back sequentially to User. User listens to a series of audio playbacks until last audio playback ends, or until User interrupts an audio playback through Barge-In, or until Program or Audio Session on Device interrupts audio playback.

According to various examples and embodiments, functionality of AudioListener VFM processing is accomplished through AudioListener VFM referencing an APM. In accordance with various examples, configurations of the APM and the Audio Segments the APM references map to dynamic runtime parameters CRUD by Program through VFC 16 during VFF 110 processing of the VFM. According to various embodiments, at start of AudioListener VFM processing, VFF 110 makes Callback to VFC 16 (458 shown in FIG. 9). VFC 16 uses this Callback to CRUD, at runtime, the initial dynamic runtime configuration parameters of the APM and its referenced Audio Segments which comprise, but not limited to, recorded audio prompt URL to playback, or text to playback, or time position where to start audio playback.

With reference to FIG. 17 and according to various embodiments, VFF 110 constructs and loads speech recognition media parameters 702 and constructs and loads an APM group for audio playback 704 containing a single APM configured using parameters from multiple configuration sources accessed through 703 comprising: Audio Listener Parameters P60 configured in AudioListener VFM (P60 illustrated in FIG. 21); Recognize Audio Parameters P70 configured in AudioListener VFM (P70 illustrated in FIG. 21); Record Audio Parameters P40 configured in AudioListener VFM (P40 illustrated in FIG. 20); and dynamic runtime parameters retrieved from KV10 (KV10 illustrated in FIG. 8). KV10 provides VFF 110 the dynamic runtime configuration parameters of the APM and its referenced Audio Segments determined and updated by VFC 16 during VFF 110 Callback made to VFC 16 at the start of VFF 110 processing the AudioListener VFM.

With reference to FIG. 17 and according to various embodiments, VFF 110 checks if an APM Group is available to be processed for audio playback 706. If APM Group is available for audio playback 707, VFF 110 checks if speech recognition has already been activated 708 since speech recognition needs to start before audio playback to allow User to provide speech input during audio playback. Speech recognition would not have yet been started 709 before start of first audio playback, so VFF 110 requests Media Controller 212 in MF 210 to “Recognize Audio” 710. Media Event Notifier 214 in MF 210 notifies VFF 110 with media events 215, VFF 110 checks the media events 714 and if “Recognize Audio Started” media event 716, VFF 110 checks if audio playback is already active 718, and if not 720, VFF 110 starts audio playback by processing an internally created PlayAudio VFM that references the APM group 550 (illustrated in FIG. 14A) which VFF 110 constructed and loaded at 704.

With reference to FIG. 17 and according to various embodiments, Media Event Notifier 214 in MF 210 notifies VFF 110 with “Play Audio Segment Ended” media event 722, VFF 110 Callbacks 114 VFC 16 with this event notification 724. According to various examples and embodiments, VFC 16 checks if other Audio Segment is available for audio playback 726: if available 727, during Callback VFC 16 CRUDs the dynamic runtime configuration parameters for the next APM 728 and updates these parameters 729 in KV10 for VFF 110 to process for next audio playback; or if not available 730, VFC 16 deletes through 732 the dynamic runtime configuration parameters 731 associated with VFF 110 creating another APM, which represents VFC 16 signaling to VFF 110 the end of all audio playback for VFM. Callback returns 733 to VFF 110, VFF 110 constructs and loads next APM Group 704. If next APM Group is valid for audio playback 707, and since speech recognition has already been started 712, VFF 110 continues audio playback by processing an internally newly created PlayAudio VFM that references the next APM group 550 (illustrated in FIG. 14A) which VFF 110 constructed and loaded at 704. If next APM Group is not valid for audio playback 744 due to VFC 16 ending audio playback 731, VFF 110 checks if speech recognition is active 746, and if so, VFF 110 requests MF 210 to “Stop Recognize Audio” 740 in order for VFF 110 to end processing of AudioListener VFM.

With reference to FIG. 17 and according to various embodiments, during a plurality of consecutive audio playback of Audio Segments during AudioListener VFM processing, Media Event Notifier 214 in MF 210 notifies VFF 110 with partial or complete “SR Hypothesis” media event 734. VFF 110 processes SR Hypothesis 950 (illustrated in FIG. 18) as described earlier in AudioDialog VFM processing with the difference of, for AudioListener VFM processing, 956 returns “Garbage” or “Timeout” 964 without the need to increment retry counters or to compare with retry maximum count thresholds. VFF 110 checks the SR Hypothesis processing result 736 and performs the following comprising: if valid SR Hypothesis, or error is encountered, VFF 110 ends its AudioListener VFM processing by requesting MF 210 simultaneously 738 to “Stop Play Audio” 740 and “Stop Recognize Audio” 742; or if “Garbage/Timeout” 737, VFF 110 checks 740 if audio playback is active, and if so, VFF 110 requests MF 210 to restart or continue to “Recognize Audio” 710, and without interruption to audio playback, so User can continue to provide speech input during audio playback, or if audio playback is not active and has ended which VFF 110 handles as the end of AudioListener VFM processing; or if “No Decision” (not shown in FIG. 17), VFF 110 ignores that without action and continues to process APM without interruption to audio playback and MF 210 continues its uninterrupted active speech recognition.

According to various examples and embodiments, during the consecutive audio playback of a plurality Audio Segments referenced by APMs constructed by VFF 110 while processing AudioListener VFM, speech recognition in MF 210 listens continuously to and processes speech input from User. According to various embodiments, it is not feasible to run a single speech recognition task indefinitely until all audio playbacks running during AudioListener VFM processing are completed. According to various embodiments, a maximum duration of a speech recognition task is configured using the parameter “Max Record Audio Duration” shown in P42 as illustrated in FIG. 20. Thereupon, during consecutive processing of APMs and audio playback of a plurality of Audio Segments, the speech recognition task resets and restarts after a fixed duration that is not tied to when the processing of APMs or the audio playback of their referenced Audio Segments start and end.

The following table 7 shows a JSON example of AudioListener VFM for processing. Table 8 following table 7 shows a JSON example of the APM referenced in AudioListener VFM from table 7.

TABLE 7

| | | |
|---|---|---|
| 1 | { | |
| 2 | ″id″: ″2020_ChatResponse″, | ← ID of VFM - Passed to client during |
| | | Callbacks. |
| 3 | ″type″: ″audioListener″, | ← Type of VFM: “audioListener”. |
| 4 | ″name″: ″Listen to AI Chat Response″, | ← Descriptive VFM name. |
| 5 | ″recognizeAudioParams″: { | ← Specifies Recognize Audio parameters. |
| 6 | ″srEngine″: ″apple″, | ← Specifies SR Engine. |
| 7 | ″langLocaleFolder″: ″en-US″, | ← Specifies Language Locale: US |
| | | English. |
| 8 | ″SRSessionParams″: { | ← Specifies SR Engine session |
| | | parameters |
| 9 | ″enablePartialResults″: true, | ← Enable partial results is enabled |
| 10 | }, | |
| 11 | }, | |
| 12 | ″audioListenerParams″: | ← Specifies Audio Listener parameters. |
| 13 | { | |
| 14 | ″APMID″: ″P_ChatResponseText″, | ← Specifies APM ID |
| 15 | }, | |
| 16 | ″recordAudioParams″: { | ← Specifies Record Audio parameters. |
| 17 | ″vadParams″: { | ← Specifies VAD Parameters. |
| 18 | ″enableVAD″: true, | ← VAD is enabled. |
| 19 | ″trimSilence″: false, | ← Do not trim silence in audio before |
| | | sending to Speech Recognizer |
| 20 | ″ minDurationToDetectSpeech ″: 200, | ← Specifies 200 milliseconds minimum |
| | | duration of detected speech energy to |
| | | transition to speech energy mode. |
| 21 | ″ minDurationToDetectSilence ″: 500, | ← Specifies 500 milliseconds minimum |
| | | duration of detected silence to transition to |
| | | silence mode. |
| 22 | }, | |
| 23 | ″aecParams″: { | ← Specifies AEC Parameters. |
| 24 | ″enableAEC″: true, | ← AEC is enabled on recorded audio. |
| 25 | } | |
| 26 | ″stopRecordParams″: { | ← Specifies parameters for audio |
| | | recording to stop. |
| 27 | ″maxPreSpeechSilenceDuration″: 8000, | |
| | | ← Stop audio recording and speech |
| | | recognition when silence duration exceeds |
| | | 8000 milliseconds before speech is |
| 28 | ″maxPostSpeechSilenceDuration″: 1000, | detected from User. |
| | | ← Stop audio recording and speech |
| | | recognition when silence duration exceeds |
| | | 1000 milliseconds after speech is no |
| 29 | }, | longer detected from User. |
| 30 | }, | |
| 31 | ″goTo″: { | ← Specifies VFMs to transition to after |
| 32 | ″maxSRErrorCount″: | VFM resumes and completes processing. |
| | ″PlayAudio_NotAbleToListen″, | ← Transition to VFM ID “ |
| | | PlayAudio_NotAbleToListen ” when |
| | | maximum SR error count is reached. |
| | ″loadPromptFailure″: | |
| 33 | ″PlayAudio_CannotPlayPrompt″, | ← Transition to VFM ID “ |
| | | PlayAudio_CannotPlayPrompt ” an APM |
| | ″internalFailure″: | load fails. |
| 34 | ″PlayAudio_HavingTechnicalIssueListening″, | ← Transition to VFM ID “ |
| | | PlayAudio_Having TechnicalIssueListening |
| | ″DEFAULT″: ″Process_RentryModule″, | ” for any internal framework failures. |
| 35 | | ← Default Transition to VFM ID |
| | ″userIntentCollection″: [ | “Process_RentryModule”. |
| 36 | | ← Specifies VFMs to transition to if User |
| | | Input is classified to a User Intent that |
| | { | matches one from User intent list. |
| 37 | ″intent″: ″ AudioListenerCommand″, | |
| 38 | ″goTo″: ″Process_ALCommand″, | ← Transition to VFM ID |
| 39 | | “Process_ALCommand” if User intent |
| | }, | matches “AudioListenerCommand”. |
| 40 | { | |
| 41 | ″intent″: ″ TransitionToSleepMode ″, | |
| 42 | ″goTo″: ″ Process_SModeRequested″, | ← Transition to VFM ID |
| 43 | | “Process_SModeRequested” if User intent |
| | }, | matches “TransitionToSleepMode”. |
| 44 | { | |
| 45 | ″intent″: ″TransitionToShutdownMode″, | |
| 46 | ″goTo″: ″Process_ShutRequested″, | ← Transition to VFM ID |
| 47 | | “Process_ShutRequested” if User intent |
| 48 | }, | matches “TransitionToShutdownMode”. |
| 49 | ], | |
| 50 | }, | |
| 51 | }, | |
| 52 | | |

TABLE 8

| | | |
|---|---|---|
| 1 | { | |
| 2 | ″id″: ″ P_ChatResponseText ″, | ← ID of APM - Passed to client during |
| | | Callbacks. Referenced from |
| | | ″2020_ChatResponse ″ VFM in Table 7 |
| 3 | ″style″: ″single″, | ← Style of APM: “single”. |
| 4 | ″textString″: ″$[ChatResponseText]″, | ← Dynamic text string assigned as the |
| | | value to the key “ChatResponseText“ by |
| | | client to speech synthesize. This value |
| | | assignment occurs during Callbacks before |
| | | processing the AudioListener VFM starts |
| | | and every time audio playback of the |
| | | assigned text string ends. |
| 5 | ″audioSegmentPlaybackParams″: { | ← Audio playback parameters for the |
| | | Audio Segment. |
| 6 | ″startPosition″: | |
| | ″$[ChatResponseStartPlayPosition]″, | ← Dynamic parameter that defines the |
| | | time position where to start audio playback |
| | | from. Value of parameter |
| | | “ChatResponseStartPlayPosition” is |
| 7 | }, | assigned by Client during Callbacks. |
| 8 | }, | |

1. A speech-enabling conversational interaction framework (hereafter “Voice Flow Framework) for processing application programming interface (API) requests from a program application (hereafter “Program”) running on a device (hereafter “Device”), said comprising:
a runtime object instantiated by Program;
a callback mechanism for Program to implement;
an event registration mechanism for Program to receive real-time event notifications from said;
a plurality of modules to interpret and process configured data structures (hereafter “VoiceFlow”), provided by Program, which upon processing by said generate a variety of managed speech-enabled conversational interactions between Program and users (hereafter “User”) of Program;
a runtime object to interface with a separate media framework that executes lower level audio and media functions on Device; and
an event registration mechanism for said to receive real-time media event notifications from media framework.

2. A Voice Flow Framework as in claim 1, wherein VoiceFlows interpreted and processed by said comprise multiple configured modules (hereafter “Voice Flow Module”) comprising:
“entry” Voice Flow Module for said to start processing a VoiceFlow;
“exit” Voice Flow Module for said to end and exit processing of a VoiceFlow;
“process” Voice Flow Modules manage said data stores and VoiceFlow processing state;
“play audio” Voice Flow Modules that said processes to perform audio playback on Device audio outputs and other audio output destinations;
“record audio” Voice Flow Modules that said processes to record audio from Device audio inputs and other audio input sources;
“audio dialog” Voice Flow Modules that said processes to produce speech-enabled audio conversations and interactions between Program and User;
“audio listener” Voice Flow Modules that said processes to produce speech-enabled audio listening interaction experience between Program and User; and
“pause resume” Voice Flow Modules that said processes to pause VoiceFlow processing at and to resume VoiceFlow processing when Program instructs said to do so.

3. A Voice Flow Framework as in claim 1, wherein said performs a callback to Program before it starts processing, before it ends processing and during processing of each Voice Flow Module.

4. A Voice Flow Framework as in claim 1, wherein said creates, retrieves, updates, and deletes (CRUD) dynamic runtime parameters configured in VoiceFlows for Program to process during said callbacks to Program while said is processing a VoiceFlow and Voice Flow Modules.

5. A Voice Flow Framework as in claim 1, wherein said CRUDs dynamic runtime parameters configured in VoiceFlows to perform actions comprising:
identify next Voice Flow Module to process after processing of current Voice Flow Module ends;
determine next audio playback modules to process with associated audio playback parameters;
determine voice activity detection (hereafter “VAD”) parameters and acoustic echo cancelation (hereafter “AEC”) parameters used for audio recording and speech recognition;
determine if a partial or complete speech recognition hypothesis from User provided speech utterance matches to a list of preconfigured valid User inputs;
determine if a partial or complete speech recognition hypothesis from User provided speech utterance is classified to a User intent that matches a list of preconfigured valid User intents;
interrupt processing of a Voice Flow Module and start processing another Voice Flow Module;
stop processing a Voice Flow Module and wait for Program request to identify next Voice Flow Module to process; or
end VoiceFlow processing.

6. A Voice Flow Framework as in claim 1, wherein said stops VoiceFlow processing when said detects, or is notified with, audio session “begin” of interruptions from Device or other Device programs.

7. A Voice Flow Framework as in claim 1, wherein said detects, or is notified with, audio session “end” of interruptions from Device or from other Device programs, and resumes VoiceFlow processing at a Voice Flow Module either identified through configuration in VoiceFlow, or determined during runtime by said from Program CRUD of dynamic runtime parameters, or set by Program through Program requests to said API.

8. A Voice Flow Framework as in claim 1, wherein said resumes audio playback after an audio session interruption ends at a specific time position in a specific audio segment CRUD by Program during said callbacks to Program or through Program requests to said API.

9. A Voice Flow Framework as in claim 1, further comprising a method for Program to request said to either interrupt Voice Flow processing, or to end Voice Flow processing, or to move Voice Flow processing to another Voice Flow Module, or to process another VoiceFlow.

10. A Voice Flow Framework as in claim 1, further comprising a method for Program to submit to said multiple VoiceFlows selected by Program during runtime for said to process in support of Program's continuous changing state while User is interfacing and interacting with Program.

11. A Voice Flow Framework as in claim 1, further comprising a method for Program to request said to customize VoiceFlow processing or produce dynamic interaction changes with User during runtime through Program requests to said API or through Program CRUDs dynamic runtime parameters configured in VoiceFlows.

12. A Voice Flow Framework as in claim 1, wherein “play audio” Voice Flow Module configured in a VoiceFlow and interpreted and processed by said, comprises references to a group of configured audio prompt modules (hereafter “Audio Prompt Module”) for said to process for audio playback where an Audio Prompt Module either references a single audio segment with its own audio playback parameters, or further comprises references to group of other Audio Prompt Modules that result in a plurality of audio segments, with each audio segment configured with its own audio playback parameters, that said manages and queues for audio playback during processing of a single “play audio” Voice Flow Module.

13. A Voice Flow Framework as in claim 1, wherein said processes an Audio Prompt Module or audio segment for audio playback according to its configured audio playback style which comprise:
“single” whereupon said processes only first configured Audio Prompt Module or first configured audio segment for audio playback;
“serial” whereupon said processes single next configured Audio Prompt Module after said reentry to continue to process the main referencing Audio Prompt Module during the same processing instance of a Voice Flow Module;
“select” whereupon said processes a configured single Audio Prompt Module or a configured single audio segment selected randomly by said for audio playback; and
“combo” whereupon said processes all configured Audio Prompt Modules or all audio segments serially.

14. A Voice Flow Framework as in claim 1, wherein said interprets and processes “record audio” Voice Flow Module configured in a VoiceFlow, said executes audio recording during audio playback with the configured option for said to perform VAD and AEC during audio recording.

15. A Voice Flow Framework as in claim 1, wherein said interprets and processes “record audio” Voice Flow Module configured in a VoiceFlow, said executes audio recording with the configured options for said to perform tasks comprising:
perform VAD on recorded audio;
remove non-speech energy data from recorded audio;
stop audio recording when maximum non-speech energy duration thresholds are reached;
stop audio recording when maximum audio recording duration thresholds are reached; or
stop audio recording when maximum detected speech energy duration thresholds are reached.

16. A Voice Flow Framework as in claim 1, wherein said interprets and processes “record audio” Voice Flow Module configured in a VoiceFlow, said executes audio recording directly from an Audio Prompt Module as the source of raw audio data to be recorded.

17. A Voice Flow Framework as in claim 1, wherein said compares a partial or a complete speech recognition hypothesis to a list of partial and complete User utterance inputs configured in “audio dialog” and “audio listener” Voice Flow Modules, said either continues to process same current Voice Flow Module or transitions to process another Voice Flow Module depending on the Voice Flow Module static or dynamic transition parameters configured in the current Voice Flow Module said is processing.

18. A Voice Flow Framework as in claim 1, further comprising a method during said callback to Program for Program to classify a partial or complete speech recognition hypothesis to a valid User intent, or to classify as an incomplete User Utterance, or to request said to handle processing of speech recognition hypothesis as a rejected or an unrecognized user utterance.

19. A Voice Flow Framework as in claim 1, wherein said compares Program's intent classification of a speech recognition partial or complete hypothesis to a valid list of User intents configured in “audio dialog” and “audio listener” Voice Flow Modules, said either continues to process same current Voice Flow Module or transitions to process another Voice Flow Module depending on the Voice Flow Module static or dynamic transition parameters configured in the current Voice Flow Module said is processing.

20. A Voice Flow Framework as in claim 1, wherein said interprets and processes “audio listener” Voice Flow Module configured in a VoiceFlow, said executes audio playback of an Audio Prompt Module referencing either statically configured audio segments or audio segments configured dynamically during runtime by Program during said callback to Program at beginning of processing the “audio listener” Voice Flow Module.

21. A Voice Flow Framework as in claim 1, wherein said interprets and processes “audio listener” Voice Flow Module configured in a VoiceFlow, said callback to Program with end of audio playback of an audio segment, during such callback Program reconfigures another audio segment or a plurality of other audio segments that said reprocesses for additional audio playback, said continues this cycle at the end of each audio segment playback until said ends execution of “audio listener” Voice Flow Module when Program does not reconfigure other audio segments for additional audio playback during said callback to program.

22. A Voice Flow Framework as in claim 1, wherein said interprets and processes “audio listener” Voice Flow Module configured in a VoiceFlow, said executes a series of consecutive speech recognition tasks, not synchronized with start and end of audio segment playbacks, to capture from User partial or complete speech recognition hypothesis which said passes through callback to program during audio playback of consecutive configured audio segments for Program to optionally classify to a User intent for said to process and to take action on.

23. A Voice Flow Framework as in claim 1, wherein said notifies Program during VoiceFlow processing with a comprehensive set of real-time events along with their associated statistics and data produced by functions comprising: Voice Flow Module processing; Audio Prompt Module Processing; audio segment playback; audio recording; speech recognition; Program state changes; audio session interruptions; audio session media changes; media permissions; and media availability, for Program to adapt its execution while User is interfacing and interacting with Program.

24. A media framework for processing application programming interface (API) requests, said comprising:
a runtime object instantiated by said client;
an event registration mechanism for said client to receive real-time media event notifications from said;
a media event notifier instantiated by said to notify said client with real-time media events;
an audio session instantiated by said and allocated to said client;
an audio recorder object instantiated by said to read raw audio from several sources (hereafter “Audio Sources”) comprising: Device audio input; local or remote URL location; and a plurality of local or remote speech synthesis engines;
an audio player object instantiated by said to write raw audio to several destinations (hereafter “Audio Destinations”) comprising: Device audio output for audio playback; local or remote URL location; voice activity detector; acoustic echo canceler; and a plurality of local or remote speech recognition engines;
a plurality of real-time audio streaming processes to transmit raw audio with associated data among Audio Sources and Audio Destinations; and
a media event observer to detect and notify said client with real-time events and updates produced by media functions comprising: audio session, media availability and media permissions changes.

25. Within a Program, a method for allocating an interface instance of Voice Flow Framework aforementioned comprising:
requesting Voice Flow Framework interface instance to allocate an audio session with specific audio session property descriptors;
requesting Voice Flow Framework interface instance to allocate and assign for Program default or named media resources comprising: audio player, audio recorder, speech recognizer and speech synthesizer;
providing Voice Flow Framework interface instance a callback function in order for Program to receive and process real time callback events from Voice Flow Framework;
registering an event listener with Voice Flow Framework interface instance so Program is notified with real time event notifications from Voice Flow Framework; and
requesting Voice Flow Framework interface instance to load and process groups of configured data structures (VoiceFlows and Audio Prompt Modules) in order to execute speech-enabled conversational interactions between Program and User.
